(19) United States
(12) Patent Application Publication
(10) Pub. No.: US 2010/0324205 A1
(43) Pub. Date: Dec. 23, 2010

(54) FLUID, FLUORINE-CONTAINING AND SINGLE-COMPONENT COMPOSITION

(76) Inventors: Alois Maier, Engelsberg (DE); Norbert Steidl, Kienberg (DE); Michael Schroers, Bad Durkheim (DE); Frank Weinelt, Billerbeck (DE); Viktoria Kraus, Neuotting (DE)

Correspondence Address: FULBRIGHT & JAWORSKI, LLP, 666 FIFTH AVE, NEW YORK, NY, 10103-3198, US

(21) Appl. No.: 12/739,354

(22) PCT Filed: Jan. 19, 2009
(86) PCT No.: PCT/EP09/50527

§ 371 Date: Jun. 21, 2010

(30) Foreign Application Priority Data
Feb. 1, 2008 (DE) 102008007190.0

(51) Int. Cl. C08L 83/04

(52) U.S. Cl. 524/588

(57) ABSTRACT

Novel fluorine-containing compositions which have improved surface properties for the permanent oil- and water-repellent surface treatment or modification of mineral and nonmineral substrates for various fields of application and are present in single-component form are claimed. These compositions have, at a reduced fluorine content, significantly improved use properties and they can, in combination with suitable stabilizing components and hydrophilic silane components, be additionally optimized in terms of their hydrophobic, oleophobic and dirt-repellent properties, and they have excellent storage stability.

The present invention relates to a liquid, fluorine-containing and single-component composition and also its use.

Fluorine-containing organosilanes and their cocondensates and polycondensates, which can be used for the simultaneous hydrophobicization and oligophobicization of mineral and nonmineral substrates, are adequately known from, for example, EP 0 846 715 A1, EP 846 716 A1, EP 846 717 A1 and EP 0 960 921 A1, DE-A199 55 047, DE-C 83 40 02, U.S. Pat. No. 3,013,066, GB 935 380, DE-A 31 00 655, EP 0 382 557 A1, EP 0 493 747 B1, EP 0 587 667 B1 and DE-A 195 44 763.

The abovementioned documents EP 0 846 715 A1, EP 846 716 A1, EP 846 717 A1, EP 0 960 921 and DE-A 199 55 047 describe (per)fluoroalkyl-functional organopolysiloxanes on a water and/or alcohol basis, which are based on (per)fluoroalkyl-functional organosilanes. The (per)fluoroalkyl-functional organosilanes described, e.g. tridecafluoro-1,1,2,2-tetrahydrooctyltrimethoxysilane and tridecafluoro-1,1,2,2-tetrahydrooctyltriethoxysilane, can only be obtained via technically complicated hydrosilylation reactions of trialkoxysilanes with unsaturated compounds, for example (per)fluoroalkylalkenes.

Since the industrial availability of the (per)fluoroalkylalkenes and thus the (per)fluoroalkyl-functional organosilanes is limited, there was a need for alternative fluorine-containing compositions which make possible a greater synthetic bandwidth with regard to the (per)fluoroalkyl component and at the same time can be produced at lower cost than the known systems. In building chemistry in particular, there is a need for inexpensive, high-performance and widely usable hydrophobicization and oligophobicization compositions for building protection.

(Per)fluoroalkyl-functional organosilanes are usually not used in concentrated form since they are extremely expensive products. Furthermore, (per)fluoroalkyl-functional organosilanes are not soluble in water.

To obtain sufficiently stable solutions or preparations of (per)fluoroalkyl-functional organosilanes and their cocondensates and polycondensates, organic solvents or emulsifiers have been used (for example DE-A 34 47 636, DE-C 36 13 384, WO 95/23830 A1, WO 95/2 3804 A1, WO 96/06895 A1, WO 97/23432 A1, EP 0 846 716 A1).

A disadvantage of solvent- or emulsifier-containing preparations of (per)fluoroalkyl-functional organosilanes and of (per)fluoroalkyl-functional organopolysiloxanes having a high proportion of alkoxy groups is that such systems are undesirable for reasons of occupational hygiene and from ecological points of view. Efforts are therefore increasingly being made to provide water-based systems having a very low proportion of volatile organic compounds (VOC).

Nitrogen-containing or aminoalkyl- and (per)fluoroalkyl-functional organopolysiloxanes which are essentially free of alkoxy groups are known as water-soluble constituents in otherwise emulsifier- or surfactant-free compositions for making surfaces oil-, water- and dirt-repellent (for example DE-A 15 18 551, EP 0 738 771 A1, EP 0 846 717 A1).

In the case of the water-based systems mentioned, a relatively high proportion of amino groups or protonated amino groups always has to be present in order to ensure good solubility in water, but this is found to be counterproductive in practice:

The hydrophilicity of the amino groups or protonated amino groups counters the efforts to provide a system which has very hydrophobic properties. In addition, the oxidation sensitivity (amine oxide formation) of the amino groups or protonated amino groups causes discoloration of the treated surfaces, which adversely affects the aesthetics.

It was therefore an object of the present invention to develop novel fluorine-containing compositions having improved surface properties for permanent oil- and water-repellent surface treatment or modification of mineral and nonmineral substrates for various applications, which do not have the above-mentioned disadvantages of the prior art but instead have very good use properties and at the same time can be produced giving regard to ecological, economic and physiological aspects.

This object is achieved according to the invention by the provision of liquid fluorine-containing and single-component compositions having a fluorine content based on the solid resin of from 5 to 75% by weight for the permanent surface treatment of porous and nonporous substrates, obtainable by firstly
a) preparing a fluorosilane component (A)(i) having a polymer-bonded fluorine content of from 5 to 95% by weight and a polymer-bonded silicon content of from 95 to 5% by weight by
   a₁) reacting from 5 to 95% by weight of a (per)fluoroalkyl alcohol component (B)(i) and/or a (per)fluoroalkylalkylenamine component (B)(ii) comprising perfluoroalkyl alcohols having terminal methylene groups (hydrocarbon spacers) of the general formula

CF₃—(CF₂)ₓ—(CH₂)_{y}—O-A_{z}-H

or

CR₃—(CR₂)ₓ—(CH₂)_{y}—O-A_{z}-H
where x=3-20, y=1-6, z=0-100, R═, independently of one another, H, F, CF₃, A=CRⁱRⁱⁱ—CRⁱⁱⁱR^{iv}—O or (CRⁱRⁱⁱ)ₐ—O or CO—. (CRⁱRⁱⁱ)_{b}—O where Rⁱ, Rⁱⁱ, Rⁱⁱⁱ, R^{iv}=, independently of one another, H, alkyl, cycloalkyl, aryl or any organic radical having in each case 1-25 carbon atoms, a, b=3-5, where the polyalkylene oxide structural unit A_{z} is a homopolymer, copolymer or block copolymer of any alkylene oxides or a polyoxyalkylene glycol or a polylactone,
and/or
a hexafluoropropene oxide (HFPO) oligomer alcohol of the general formula

CF₃—CF₂—CF₂-[O—CF(CF₃)—CF₂]ₓ—O—CF(CF₃)—(CH₂)_{y}—O-A_{z}-H
and/or
a fluorine-modified macromonomer or telechelic polymer (B)(iii), for example a hydroxy-functional reaction product of the components (F)(i) and (F)(ii) with the components (Q)(i) and (Q)(ii), having a polymer-bonded fluorine content of from 1 to 99% by weight, a molecular mass of from 100 to 10 000 dalton and in each case one or more reactive (cyclo)aliphatic and/or aromatic hydroxyl group(s) and/or primary and/or secondary amino group(s) and/or mercapto group(s) and containing the structural elements

—(CF₂—CF₂)ₓ—

and/or

—(CR₂—CR₂)ₓ—

and/or

—[CF₂—CF(CF₃)—O]ₓ—

and/or

—(CR₂—CR₂—O)ₓ—
arranged intrachenally and/or laterally and/or terminally in the main chain and/or side chain
with from 95 to 5% by weight of an isocyanatoalkylalkoxysilane component (C)(i) comprising a 3-isocyanatopropyltrialkoxysilane and/or a 3-isocyanatopropylalkoxyalkylsilane and/or isocyanato-alkylalkoxysilanes of the general formula

OCN—(CR²₂)_{y′}—Si(OR¹)_{3-x′}R²_{x′}
where x′=0-2, y′=1-3 and R¹, R²═, independently of one another, alkyl, cycloalkyl, aryl, any organic radical in each case having 1-25 carbon atoms,
and/or another isocyanatosilane component (C)(ii) having a molecular mass of from 200 to 2000 dalton and in each case one or more (cyclo)aliphatic and/or aromatic isocyanato group(s) and one or more alkoxysilane group(s), with the reaction preferably being carried out in a molar ratio of 1:1 in any way,
and/or
a_{2.1}) reacting from 5 to 95% by weight of a (per)fluoroalkyl alcohol component (B)(i) and/or a (per)fluoroalkylalkylenamine component (B)(ii) and/or fluorine-modified macromonomers or telechelic polymers (B)(iii) with from 75 to 5% by weight of a polyisocyanate component (D)(i) comprising at least one diisocyanate, polyisocyanate, polyisocyanate derivative or polyisocyanate homologue having two or more (cyclo)aliphatic and/or aromatic isocyanate groups of identical or different reactivity, with the reaction conditions and the selectivities of the components (8) and (D) being selected so that only one isocyanate group of the component (D)(i) reacts with the component (B),
   a_{2.2}) subsequently reacting the preadduct from step a_{2.1}) with from 75 to 5% by weight of an aminoalkylalkoxysilane component (E)(i) comprising a 3-aminopropyltrialkoxysilane and/or a (substituted) 3-aminopropylalkoxyalkylsilane of the general formula

R³₂N—(CR³₂)_{y′}—Si(OR¹)_{3-x′}R²_{x′}
where x′=0-2, y′=1-6 and R¹, R²═, independently of one another, alkyl, cycloalkyl, aryl, any organic radical having in each case 1-25 carbon atoms, R³═, independently of one another, alkyl, cycloalkyl, aryl, any organic radical having 1-25 carbon atoms, (R¹O)_{3-x′}R²_{x′}Si(CR³₂)_{y′}, R^{3′}₂N—(CR^{3′}₂)_{y′}—[NH—(CR^{3′}₂)_{y′}]ₙ′ where n′=0-10, where R^{3′}═, independently of one another, alkyl, cycloalkyl, aryl, any organic radical having in each case 1-25 carbon atoms,
and/or an aminosilane component (E)(ii) different from (E)(i) having a molecular mass of from 200 to 2000 dalton and in each case one or more primary and/or secondary and/or tertiary amino group(s) and one or more alkoxysilane group(s), with the reaction preferably being carried out in a molar ratio of 1:1:1 in any way,
and/or
a₃) reacting from 5 to 95% by weight of a (per)fluoroalkylalkylene isocyanate component (B)(iv) of the general formula

CF₃—(CF₂)ₓ—(CH₂)_{y}—NCO

or

CR₃—(CR₂)ₓ—(CH₂)_{y}—NCO
having a molecular mass of from 200 to 2000 dalton and one or more (cyclo)aliphatic and/or aromatic isocyanato group(s) with from 95 to 5% by weight of an aminosilane component (E)(i) and/or (E)(ii), giving an adduct of the general formula

(B)(iv)-(E)
where (B)(iv)=protonated component (B)(iv) and (E)=deprotonated components (E)(i) and/or (E)(ii),
with the reaction preferably being carried out in a molar ratio of 1:1 in any way,
and/or
a₄) reaction products having two or more hydroxyl groups from 5 to 95% by weight of a (per)fluoroalkylalkane carboxylic acid (derivative) component (B)(v) of the general formula

CF₃—(CF₂)ₓ—(CH₂)_{y}—COR⁴

or

CR₃—(CR₂)ₓ—(CH₂)_{y}—COR⁴
where R⁴═F, Cl, Br, I, OH, OMe, OEt,
having a molecular mass of from 200 to 200 dalton and one or more carboxylic acid (derivative) group(s) with from 95 to 5% by weight of an aminosilane component (E)(i) and/or (E)(ii), resulting in elimination of HR⁴ to give an adduct of the general formula

(B)(v)-(E)
where (B)(v)=carbonyl radical of the component (B)(v) and (E)=deprotonated components (E)(i) and/or (E)(ii),
with the reaction preferably being carried out in a molar ratio of 1:1 in any way,
and/or
a₅) reacting from 5 to 95% by weight of a hexafluoropropene oxide component (F)(i) comprising monofunctional hexafluoropropene oxide oligomers of the general formula

CF₃—CF₂—CF₂—O—(CF(CF₃)—CF₂—O)ₙ—CF(CF₃)—COR⁴
where m=1-20
with from 95 to 5% by weight of an aminosilane component (E)(i) and/or (E)(ii), resulting in elimination of HR⁴ to form adducts of the

(F)(i)-(E)
where (F)(i)=carbonyl radical of the component (F)(i) and (E)=deprotonated components (E)(i) and/or (E)(ii), with the reaction preferably being carried out in a molar ratio of 1:1 in any way,
and/or
a₆) reacting from 5 to 95% by weight of a hexafluoropropene oxide component (F)(ii) comprising bifunctional hexafluoropropene oxide oligomers of the general formula

R⁴OC—CF(CF₃)—(O—CF₂—CF(CF₃))ₙ—O—(CF₂)ₒ—O—(CF(CF₃)—CF₂—O)ₙ—CF(CF₃)—COR⁴
where n=1-10, o=2-6
with from 95 to 5% by weight of an aminoalkylalkoxysilane component (E)(i) and/or (E)(ii), resulting in elimination of HR⁴ to give adducts of the general formula

(E)-(F)(ii)-(E)
where (F)(ii)=carbonyl radical of the component (F)(i) and (E)=deprotonated components (E)(i) and/or (E)(ii),
with the reaction preferably being carried out in a molar ratio of 1:1 in any way,
and/or
a₇) reacting from 5 to 95% by weight of a (per)fluoroalkyl alcohol component (B)(i) and/or a (per)fluoroalkylalkylenamine component (B)(ii) and/or a fluorine-modified macromonomer or telechelic polymer (B)(iii) with from 75 to 5% by weight of an aminoalkylalkoxysilane component (E)(i) and/or (E)(ii) and from 75 to 5% by weight of a polyisocyanate component (D)(ii) comprising a triisocyanate, polyisocyanate, polyisocyanate derivative or polyisocyanate homologue having at least three (cyclo)aliphatic and/or aromatic isocyanate groups of identical or different reactivity, with the reaction in the case of trifunctional isocyanates preferably being carried out in a molar ratio of 2:1:1 or 1:2:1 in any way,
and/or
a₈) reacting from 5 to 75% by weight of a (per)fluoroalkyl alcohol component (B)(i) and/or a (per)fluoroalkylalkylenamine component (B)(ii) and/or a fluorine-modified macromonomer or telechelic polymer (B)(iii) with from 50 to 5% by weight of an aminoalkylalkoxysilane component (E)(i) and/or (E)(ii), from 50 to 5% by weight of a monofunctional polyalkylene glycol component (G)(i) and/or a monofunctional polyoxyalkylenamine component (G)(ii) comprising monohydroxyfunctional alkyl/cycloalkyl/arylpolyethylene glycols and/or alkyl/cycloalkyl/arylpoly(ethylene oxide-block-alkylene oxide) and/or alkyl/cycloalkyl/arylpoly(ethylene oxide-co-alkylene oxide) and/or alkyl/cycloalkyl/arylpoly(ethylene oxide-ran-alkylene oxide) comprising from 25 to 99.9% by weight of ethylene oxide and from 0 to 75% by weight of a further alkylene oxide having from 3 to 20 carbon atoms comprising propylene oxide, butylene oxide, dodecyl oxide, isoamyl oxide, oxetane, substituted oxetanes, α-pinene oxide, styrene oxide, tetrahydrofuran or further aliphatic or aromatic alkylene oxides having from 4 to 20 carbon atoms per alkylene oxide or mixtures thereof, of the general formula

R⁵—O-A_{z}-H
where z′=5-150, R⁵=alkyl, cycloalkyl, aryl, any organic radical having 1-25 carbon atoms,
and/or
monoamino-functional alkyl/cycloalkyl/arylpolyethylene glycols and/or alkyl/cycloalkyl/arylpoly(ethylene oxide-block-alkylene oxide) and/or alkyl/cycloalkyl/arylpoly(ethylene oxide-co-alkylene oxide) and/or alkyl/cycloalkyl/arylpoly(ethylene oxide-ran-alkylene oxide) comprising from 25 to 99.9% by weight of ethylene oxide and from 0 to 75% by weight of a further alkylene oxide having from 3 to 20 carbon atoms comprising propylene oxide, butylene oxide, dodecyl oxide, isoamyl oxide, oxetane, substituted oxetanes, α-pinene oxide, styrene oxide, tetrahydrofuran or further aliphatic or aromatic alkylene oxides having from 4 to 20 carbon atoms per alkylene oxide or mixtures thereof, of the general formula

R⁵—O—(CRⁱRⁱⁱCRⁱⁱⁱR^{iv}—O)_{z′-1}—CRⁱRⁱⁱ—CRⁱⁱⁱR^{iv}—NH₂
and from 50 to 5% by weight of a polyisocyanate component (D)(ii), with the reaction in the case of trifunctional isocyanates preferably being carried out in a molar ratio of 1:1:1:1 in any way,
and/or
a₉) reacting from 5 to 95% by weight of a (per)fluoroalkyl alcohol component (B)(i) and/or a (per)fluoroalkylalkylenamine component (B)(ii) and/or a fluorine-modified macromonomer or telechelic polymer (B)(iii) with from 75 to 5% by weight of an aminoalkylalkoxysilane component (E)(i) and/or (E)(ii) and from 75 to 5% by weight of a triazine component (H) comprising cyanuric chloride or 2,4,6-trichloro-1,3,5-triazine, with the reaction preferably being carried out in a molar ratio of 2:1:1 or 1:2:1 in any way,
and/or
a₁₀) reacting from 5 to 75% by weight of a (per)fluoroalkyl alcohol component (B)(i) and/or a (per)fluoroalkylalkylenamine component (B)(ii) and/or a fluorine-modified macromonomer or telechelic polymer (B)(iii) with from 50 to 5% by weight of an aminoalkylalkoxysilane component (E)(i) and/or (E)(ii), from 50 to 5% by weight of a monofunctional polyalkylene glycol component (G)(i) and/or a monofunctional polyoxyalkylenamine component (G)(ii) and from 50 to 5% by weight of a triazine component (H) comprising cyanuric chloride or 2,4,6-trichloro-1,3,5-triazine, with the reaction preferably being carried out in a molar ratio of 1:1:1:1 in any way,
and/or
a₁₁) reacting from 5 to 75% by weight of a (per)fluoroalkyl alcohol component (B)(i) and/or a (per)fluoroalkylalkylenamine component (B)(ii) and/or a fluorine-modified macromonomer or telechelic polymer (B)(iii) with from 50 to 5% by weight of an aminoalkylalkoxysilane component (E)(i) and/or (E)(ii), from 50 to 5% by weight of a polyfunctional polyalkylene glycol component (G)(iii) and/or a polyfunctional polyoxyalkylenamine component (G)(iv) comprising polyhydroxy-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) comprising from 25 to 99.9% by weight of ethylene oxide and from 0 to 75% by weight of a further alkylene oxide having from 3 to 20 carbon atoms comprising propylene oxide, butylene oxide, dodecyl oxide, isoamyl oxide, oxetane, substituted oxetanes, α-pinene oxide, styrene oxide, tetrahydrofuran or further aliphatic or aromatic alkylene oxides having from 4 to 20 carbon atoms per alkylene oxide or mixtures thereof, of the general formula

R⁶(—O-A_{z″}—H)_{z″}
where z″=2-6, R⁶=alkyl, cycloalkyl, aryl, any organic radical having 1-25 carbon atoms,
and/or
polyamino-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) comprising from 25 to 99.9% by weight of ethylene oxide and from 0 to 75% by weight of a further alkylene oxide having from 3 to 20 carbon atoms comprising propylene oxide, butylene oxide, dodecyl oxide, isoamyl oxide, oxetane, substituted oxetanes, α-pinene oxide, styrene oxide, tetrahydrofuran or further aliphatic or aromatic alkylene oxides having from 4 to 20 carbon atoms per alkylene oxide or mixtures thereof, of the general formula

R⁶(—O-A_{z′-1}-CRⁱRⁱⁱ—CRⁱⁱⁱR^{iv}—NH₂)_{z″}
and from 50 to 5% by weight of a polyisocyanate component (D)(i), with the reaction in the case of dihydroxy-functional glycols preferably being carried out in a molar ratio of 1:1:1:2 in any way,
and/or
a₁₂) reacting from 5 to 75% by weight of a (per)fluoroalkyl alcohol component (B)(i) and/or a (per)fluoroalkylalkylenamine component (B)(ii) and/or a fluorine-modified macromonomer or telechelic polymer (B)(iii) with from 50 to 5% by weight of an aminoalkylalkoxysilane component (E)(i) and/or (E)(ii), from 50 to 5% by weight of a hydroxycarboxylic acid component (I) comprising a monohydroxycarboxylic acid and/or a dihydroxycarboxylic acid having one and/or two hydroxyl group(s) which is/are reactive towards isocyanates and a carboxyl group which is inert towards polyisocyanates and from 50 to 5% by weight of a polyisocyanate component (D)(ii) comprising at least one triisocyanate, polyisocyanate, polyisocyanate derivative or polyisocyanate homologue having at least three (cyclo)aliphatic and/or aromatic isocyanate groups of identical or different reactivity, with the reaction in the case of trifunctional isocyanates preferably being carried out in a molar ratio of 1:1:1:1 in any way,
and/or
a₁₃) reacting from 5 to 75% by weight of a (per)fluoroalkyl alcohol component (B)(i) and/or a (per)fluoroalkylalkylenamine component (B)(ii) and/or a fluorine-modified macromonomer or telechelic polymer (B)(iii) with from 50 to 5% by weight of an aminoalkylalkoxysilane component (E)(i) and/or (E)(ii), from 50 to 5% by weight of an NCN component (J) comprising cyanamide having an NH-acid amino group which is reactive towards polyisocyanates and from 50 to 5% by weight of a polyisocyanate component (D)(ii) comprising at least one triisocyanate, polyisocyanate, polyisocyanate derivative or polyisocyanate homologue having at least three (cyclo)aliphatic and/or aromatic isocyanate groups of identical or different reactivity, with the reaction in the case of trifunctional isocyanates preferably being carried out at a molar ratio of 1:1:1:1 in any way,
and/or
a₁₄) reacting from 5 to 95% by weight of a (per)fluoroalkyl alcohol component (B)(i) and/or a (per)fluoroalkylalkylenamine component (B)(ii) and/or a fluorine-modified macromonomer or telechelic polymer component (B)(iii), from 75 to 5% by weight of a carbonyl component (K) of the general formula

X—CO—Y
where X, Y═, independently of one another, F, Cl, Br, I, CCl₃, R⁷, OR⁷ where R⁷=alkyl, cycloalkyl, aryl, any organic radical having 1-25 carbon atoms, 0-10 N atoms and 0-10 O atoms,
with from 75 to 5% by weight of an aminoalkylalkoxysilane component (E)(i) and/or (E)(ii), resulting in, in the first stage, elimination of HX and/or HY to give an adduct of the general formula

(B)—CO—Y and/or X—CO—(B)

or

(E)-CO—Y and/or X—CO-(E)
where (B)=deprotonated components (B)(i) and/or (B)(ii) and/or (B)(iii), (E)=deprotonated components (E)(i) and/or (E)(ii)
and, in the second stage, elimination of HX and/or HY to give an adduct of the general formula

(B)—CO-(E),
with the reaction preferably being carried out in a molar ratio of 1:1:1 in any way,
or
reacting from 5 to 95% by weight of a preformed adduct of the general formula

(B)—CO—Y and/or X—CO—(B)
with from 95 to 5% by weight of an aminoalkylalkoxysilane component (E)(i) and/or (E)(ii), resulting in elimination of HX and/or HY to give an adduct of the general formula

(B)—CO-(E),
with the reaction being preferably carried out in a molar ratio of 1:1 in any way,
or
reacting from 5 to 95% by weight of a preformed adduct of the general formula

(E)-CO—Y and/or X—CO-(E)
with from 95 to 5% by weight of a (per)fluoroalkyl alcohol component (B)(i) and/or a (per)fluoroalkylalkylenamine component (B)(ii) and/or a fluorine-modified macromonomer or telechelic polymer component (B)(iii), resulting in elimination of HX and/or HY to give an adduct of the general formula

(B)—CO-(E),
with the reaction preferably being carried out in a molar ratio of 1:1 in any way,
and/or
a₁₅) replacing the aminoalkylalkoxysilane component (E)(i) and/or the aminosilane component (E)(ii) in the case of the reaction products a₂) to a₁₄) by a mercaptoalkylalkoxysilane component (L)(i) comprising a 3-mercaptopropyltrialkoxysilane of the general formula

HS—(CR³₂)_{y}—Si(OR¹)_{3-x′}R²_{x′}
and/or by another mercaptosilane component (L)(ii) having a molecular mass of from 200 to 2000 dalton and having one or more mercapto group(s) and one or more alkoxysilane group(s)
and/or
a₁₆) reacting from 5 to 95% by weight of a (per)fluoroalkylalkylene oxide component (M) of the general formula

CF₃—(CF₂)ₓ—(CH₂)_{y}—CHOCH₂

or

CR₃—(CR₂)ₓ—(CH₂)_{y}—CHOCH₂

or

CR₃—(CR₂)ₓ—(CH₂)_{y}—O—CH₂—CHOCH₂
having a molecular mass of from 200 to 2000 dalton and one or more epoxy group(s) with from 95 to 5% by weight of an aminosilane component (E)(i) and/or (E)(ii), with the reaction preferably being carried out in a molar ratio of 1:1 or 1:2 in any way,
and/or
a₁₇) reacting from 5 to 95% by weight of a (per)fluoroalkylalkylene oxide component (M), from 75 to 5% by weight of an epoxyalkylolalkoxysilane component (N)(i) and/or a component (N)(ii) different from (N)(i) comprising a (substituted) 3-glycidyloxy-propyltrialkoxysilane of the general formula

CH₂OCH—CH₂—O—(CR³₂)_{y}—Si(OR¹)_{3-x′}R²_{x′}
having a molecular mass of from 200 to 2000 dalton and one or more epoxy group(s) with from 75 to 5% by weight of a polyamine component (O) having a molecular mass of from 60 to 5000 dalton and one or more (cyclo)aliphatic and/or aromatic primary and/or secondary amino group(s) which is/are reactive towards epoxide groups and, if appropriate, one or more hydroxyl group(s), with the reaction preferably being carried out in a molar ratio of 1:1:1 or 2:2:1 in any way,
and/or
a₁₈) reacting from 5 to 95% by weight of an epoxy-functional polyhedral oligomeric polysilasesquioxane component (POSS) (P)(i) having one or more epoxy groups and one or more perfluoroalkyl groups of the general formula

(R⁸ᵤR⁹ᵥR¹⁰₂SiO_{1.5})ₚ
where 0<u<1, 0<v<1, 0<w<1, u+v+w=1,
p=4, 6, 8, 10, 12 and R⁸, R⁹, R¹⁰ independently of one another, any inorganic and/or organic and if appropriate polymeric radical having from 1 to 250 carbon atoms and from 0 to 50 N atoms and/or from 1 to 50 O atoms and/or from 3 to 100 F atoms and/or from 0 to 50 Si atoms and/or from 0 to 50 S atoms,
with from 95 to 5% by weight of an aminosilane component (E)(i) and/or (E)(ii), with the reaction preferably being carried out in a molar ratio of 1:(>) 1 in any way,
and/or
a₁₉) reacting from 5 to 95% by weight of an amino-functional polyhedral oligomeric polysilasesquioxane component (POSS) (P)(ii) having one or more amino groups and one or more perfluoroalkyl groups of the general formula

(R⁸ᵤR⁹ᵥR¹⁰_{w}SiO_{1.5})ₚ
with from 95 to 5% by weight of an isocyanatoalkylalkoxysilane component (C)(i) and/or a component (C)(ii) different from (C)(i), with the reaction preferably being carried out in a molar ratio of 1:(>) 1 in any way,
and/or
a₂₀) reacting from 5 to 95% by weight of a (meth)acryloyl-functional polyhedral oligomeric polysilasesquioxane component (POSS) (P)(iii) having one or more (meth)acryloyl groups and one or more perfluoroalkyl groups of the general formula

(R⁸ᵤR⁹ᵥR¹⁰_{w}SiO_{1.5})ₚ
with from 95 to 5% by weight of an amino alcohol component (Q)(i) having one or more (cyclo)aliphatic and/or aromatic primary and/or secondary amino group(s) which is/are reactive towards epoxide groups and one or more hydroxyl group(s) having a molecular mass of from 60 to 5000 dalton and/or another amino alcohol component (Q)(ii), with the reaction preferably being carried out in a molar ratio of 1:(>) 1 in any way,
or using preformed fluorosilanes (A)(ii) such as
a₂₁) (per)fluoroalkylalkoxysilanes of the general formula

CF₃—(CF₂)ₓ—(CH₂)_{y}—Si(OR¹)_{3-x′}R²_{x′}

or

CR₃—(CR₂)ₓ—(CH₂)_{y}—Si(OR¹)_{3-x′}R²_{x′}
and/or
a₂₂) other reaction products containing the structural elements

—(CF₂—CF₂)ₓ—

and/or

—(CR₂—CR₂)ₓ—

and/or

—[CF₂—CF(CF₃)—O]ₓ—

and/or

—(CR₂—CR₂—O)ₓ—

and

—Si(OR¹)_{3-x′}R²_{x′},
where from 2.5 to 250 parts by weight of the pure fluorosilane component (A) and also from 0 to 10 parts by weight of a catalyst component (R) and from 0 to 250 parts by weight of a solvent component (S)(i) are present,
b₁) if appropriate partially or completely removing the solvent component (S)(i) from step a) by distillation before, during or after the reaction,
b₂) if appropriate partially or completely removing the catalyst component (R) from step a) by means of suitable absorption materials or other measures after the reaction,
b₃) dissolving the mixture from step a) in from 0 to 250 parts by weight of a solvent component (S)(ii) before, during or after the reaction,
c₁) (partially) hydrolysing or silanolizing the mixture from steps a) or b) with from 0 to 100 parts by weight of an aminosilane component (E)(i) and/or (E)(ii) and from 0.1 to 100 parts by weight of a stabilizing component (T) comprising
   c_{1.1}) reaction products of from 5 to 95% by weight of an amino alcohol component (Q)(i) and/or another amino alcohol component (Q)(ii) and from 95 to 5% by weight of an isocyanatosilane component (C)(i) and/or (C)(ii), with the reaction preferably being carried out in a molar ratio of 1:1 in any way,
   and/or
   c_{1.2}) reaction products of from 5 to 75% by weight of an amino alcohol component (Q)(i) and/or another amino alcohol component (Q)(ii), from 75 to 5% by weight of an aminosilane component (E)(i) and/or (E)(ii) and from 75 to 5% by weight of a polyisocyanate component (D)(i), with the reaction preferably being carried out in a molar ratio of 1:1:1 in any way,
   and/or
   c_{1.3}) reaction products of from 5 to 95% by weight of a hydroxycarboxylic acid component (I) and from 95 to 5% by weight of an isocyanatosilane component (C)(i) and/or (C)(ii), with the reaction preferably being carried out in a molar ratio of 1:1 in any way,
   and/or
   c_{1.4}) reaction products of from 5 to 75% by weight of a hydroxycarboxylic acid component (I), from 75 to 5% by weight of an aminosilane component (E)(i) and/or (E)(ii) and from 75 to 5% by weight of a polyisocyanate component (D)(i), with the reaction preferably being carried out in a molar ratio of 1:1:1 in any way,
   and/or
   c_{1.5}) reaction products of from 5 to 95% by weight of an NCN component (J) and from 95 to 5% by weight of an isocyanatosilane component (C)(i) and/or (C)(ii), with the reaction preferably being carried out in a molar ratio of 1:1 in any way,
   and/or
   c_{1.6}) reaction products of from 5 to 75% by weight of an NCN component (J), from 75 to 5% by weight of an aminosilane component (E)(i) and/or (E)(ii) and from 75 to 5% by weight of a polyisocyanate component (D)(i), with the reaction preferably being carried out in a molar ratio of 1:1:1 in any way,
   and/or
   c_{1.7}) reaction products of from 5 to 95% by weight of an aminosilane component (E)(i) and/or (E)(ii) and from 95 to 5% by weight of an acid component (U)(i) comprising unsaturated carboxylic acids, with the reaction preferably being carried out in a molar ratio of 1:>1 in any way,
   and/or
   c_{1.8}) reaction products of from 5 to 95% by weight of an aminosilane component (E)(i) and/or (E)(ii) and from 95 to 5% by weight of an acid component (U)(ii) comprising unsaturated carboxylic anhydrides, with the reaction preferably being carried out in a molar ratio of 1:>1 in any way,
   and/or
   c_{1.9}) reaction products of from 5 to 95% by weight of an aminosilane component (E)(i) and/or (E)(ii) and from 95 to 5% by weight of an acid component (U)(iii) comprising γ- and/or δ-lactones of onic acids or sugar acids or polyhydroxy(di)carboxylic acids or polyhydroxycarboxylic aldehydes, with the reaction in the case of monolactones preferably being carried out in a molar ratio of 1:1 and in the case of dilactones preferably being carried out in a molar ratio of 2:1 in any way to give hydrophilic silanes of the general formula

(E)-CO—[CH(OH)₄]—CH₂OH

and/or

(E)-CO—[CH(OH)₄]—CHO

and/or

(E)-CO—[CH(OH)₄]—CO-(E),
where the reaction products c_{1.1}) to c_{1.9}) contain from 0 to 10 parts by weight of a catalyst component (R), from 0 to 250 parts by weight of a solvent component (S)(i) and from 0 to 250 parts by weight of a solvent component (S)(ii),
and from 0.1 to 100 parts by weight of a hydrophilic silane component (V) comprising
c_{1.10}) a nonionic silane component (E)(iii) of the general formula

R¹¹—O-A_{z′}—(CH₂)_{y′}—Si(OR¹)_{3-x′}R²_{x′}

and/or

HO-A_{z′}—(CH₂)_{y′}—Si(OR¹)_{3-x′}R²_{x′}
where R¹¹=alkyl, cycloalkyl, aryl, any organic radical having in each case 1-25 carbon atoms,
and/or
c_{1.11}) reaction products of from 5 to 95% by weight of a monofunctional polyalkylene glycol component (G)(i) and/or a monofunctional polyoxyalkylenamine component (G)(ii) and/or a polyfunctional polyalkylene glycol component (G)(iii) and/or a polyfunctional polyoxyalkylenamine component (G)(iv) and from 95 to 5% by weight of an isocyanatosilane component (C)(i) and/or (C)(ii), with the reaction in the case of monohydroxy- or monoamino-functional glycols preferably being carried out in a molar ratio of 1:1 in any way,
and/or
c_{1.12}) reaction products of from 5 to 75% by weight of a monofunctional polyalkylene glycol component (G)(i) and/or a monofunctional polyoxyalkylenamine component (G)(ii) and/or a polyfunctional polyalkylene glycol component (G)(iii) and/or a polyfunctional polyoxyalkylenamine component (G)(iv), from 75 to 5% by weight of an aminosilane component (E)(i) and/or (E)(ii) and from 75 to 5% by weight of a polyisocyanate component (D)(i), with the reaction in the case of monohydroxy- or monoamino-functional glycols preferably being carried out in a molar ratio of 1:1:1 in any way,
and/or
c_{1.13}) reaction products of from 5 to 95% by weight of a polyoxyalkylenamine component (G)(ii) and/or a polyfunctional polyoxyalkylenamine component (G)(iv) and from 95 to 5% by weight of an epoxyalkylolalkoxysilane component (N)(i) and/or an epoxysilane component (N)(ii) different from (N)(i), with the reaction in the case of monoamino-functional glycols preferably being carried out in a molar ratio of 1:1 or 1:2 in any way,
and/or
c_{1.14}) reaction products of from 5 to 75% by weight of a monofunctional polyalkylene glycol component (G)(i) and/or a monofunctional polyoxyalkylenamine component (G)(ii), from 50 to 5% by weight of an aminosilane component (E)(i) and/or (E)(ii) and from 50 to 5% by weight of a polyisocyanate component (D)(ii), with the reaction in the case of trifunctional isocyanates preferably being carried out in a molar ratio of 1:2:1 or 2:1:1 in any way,
and/or
c_{1.15}) reaction products of from 5 to 75% by weight of a monofunctional polyalkylene glycol component (G)(i) and/or a monofunctional polyoxyalkylenamine component (G)(ii), from 50 to 5% by weight of an aminosilane component (E)(i) and/or (E)(ii) and from 50 to 5% by weight of a triazine component (H) comprising cyanuric chloride or 2,4,6-trichloro-1,3,5-triazine, with the reaction preferably being carried out in a molar ratio of 1:2:1 or 2:1:1 in any way,
where the reaction products c_{1.10}) to c_{1.15}) contain from 0 to 10 parts by weight of a catalyst component (R), from 0 to 250 parts by weight of a solvent component (S)(i) and from 0 to 250 parts by weight of a solvent component (S)(ii),
by means of from 0.25 to 25 parts by weight of water,
c₂) partially or completely neutralizing the (amino-functional) adduct by means of from 0 to 75 parts by weight of an acid component (U)(iv) or from 0 to 75 parts by weight of another neutralization component (W), c₃) if appropriate partially or completely removing the liberated alcohol and/or the solvent components (S)(i) and/or (S)(ii) by distillation before, during or after the reaction,
d₁) subsequently or simultaneously dissolving or dispersing and oligomerizing the reaction product from step c) in from 997.05 to 124 parts by weight of water,
d₂) if appropriate partially or completely removing the liberated alcohol and/or the solvent components (S)(i) and/or (S)(ii) by distillation before, during or after the reaction and, if appropriate, partially or completely removing the catalyst component (R) by means of suitable absorption materials or other measures before, during or after the reaction so that not more than from 0 to 1 part by weight of a catalyst component (R), from 0 to 25 parts by weight of a solvent component (S)(i) and from 0 to 25 parts by weight of a solvent component (S)(ii) are present,
e) where, if appropriate, during or after steps a) and/or b) and/or c) and/or d), from 0 to 50 parts by weight or from 0 to 60 parts by weight of a formulation component (Y)(i) is added in any way and/or from 0 to 50 parts by weight or from 0 to 60 parts by weight of a functionalization component (Z) comprising
   e₁) an aminosilicone oil component (E)(iv) of the general formula

HO—[Si(CH₃)₂—O]_{c}—Si(CH₃)[(CH₂)₃NH(CH₂)₂NH₂]—O—[Si(CH₃)₂—O]_{c}—H

or

R′O—[Si(CH₃)₂—O]_{c}—Si(CH₃)[(CH₂)₃NH(CH₂)₂NH₂]—O—[Si(CH₃)₂—O_{c}]—R′

(H₃CO)₂Si[(CH₂)₃NH(CH₂)₂NH₂]—[Si(CH₃)₂—O]_{c}—Si[(CH₂)₃NH(CH₂)₂NH₂](OCH₃)₂
where c=1-100 and R′═H, Me, Et
and/or
e₂) a low molecular weight silane component (E)(v) of the general formula

R¹²—Si(OR¹)_{3-x′}R²_{x′}
where R¹²═OR¹, R²═, independently of one another, alkyl, cycloalkyl, aryl, any organic radical having 1-25 carbon atoms,
and/or
e₃) a hydrophilicized aqueous silane component (E)(vi) comprising (alcohol-free) aminosilane hydrolysates and/or (di/tri)amino/alkyl-functional siloxane cooligomers and/or amino/vinyl-functional siloxane cooligomers and/or epoxy-functional siloxane cooligomers
and/or
e₄) a (reactive) nanoparticle component (Y)(ii) comprising inorganic and/or organic nanoparticles or nanocomposites in the form of primary particles and/or aggregates and/or agglomerates, where the nanoparticles may be hydrophobicized and/or doped and/or coated and additionally surface-modified with reactive amino and/or hydroxyl and/or mercapto and/or isocyanato and/or epoxy and/or methacryloyl and/or silane groups of the general formula —Si(OR¹)_{3-x′}R²_{x′},
is/are added and/or coreacted.

It has suprisingly been found that the liquid fluorine-containing compositions of the invention not only make it possible to obtain coating or impregnation systems which are permeable to water vapour for the permanent oil-, water- and dirt-repellent surface treatment or modification of mineral and nonmineral substrates but these also have use properties which are significantly improved compared to the prior art at the same or even lower fluorine content. The use of suitable fluorosilane components in combination with suitable stabilizing components and hydrophilic silane components enables the critical surface tensions γ_{c} and the contact angle θ of the fluorine-containing compositions according to the invention to be optimized so that the hydrophobic, oleophobic and dirt-repellent properties are brought to bear in the respective applications even at a very low dosage of active composition or very low fluorine content. In addition, it could not have been foreseen that the liquid fluorine-containing compositions of the invention can also be produced without solvent or with a low solvent content. Apart from (per)fluoroalkyl-functional organosilanes, single-component (per)fluoroalkyl-functional organopolysiloxane precondensates and single-component (per)fluoroalkyl-functional organopolysiloxane condensates for various fields of application can be obtained. When suitable stabilizing components are used, (per)fluoroalkyl-functional organopolysiloxane precondensates and (per)fluoroalkyl-functional organopolysiloxane condensates without free amino groups can also be obtained. When suitable hydrophilic silane components are used, (per)fluoroalkyl-functional organopolysiloxane precondensates and (per)fluoroalkyl-functional organopolysiloxane condensates having improved run-off behaviour and improved storage stability are also obtained.

As suitable fluorosilane component (A)(i), it is possible to use, for example, (per)fluoroalkyl- and/or polyhexafluoropropene oxide-modified and silane-modified reaction products produced by (poly)addition reaction and/or addition/elimination reactions.

Suitable preformed fluorosilane components (A)(ii) are, for example, the commercial products DYNASILAN® F8161 (tridecafluorooctyltrimethoxysilane), DYNASILAN® F8261 (tridecafluorooctyltriethoxysilane), DYNASILAN® F8263 (fluoroalkylsilane formulation, ready-to-use in isopropanol), DYNASILAN® F8800 (modified fluoroalkylsiloxane, water-soluble), DYNASILAN® F8815 (aqueous, modified fluoroalkylsiloxane) from Degussa AG or suitable combinations thereof.

As suitable (per)fluoroalkyl alcohol component (B)(i), it is possible to use, for example, 3,3,4,4,5,5,6,6,7,7,8,8,8-tridecafluorooctan-1-ol, 3,3,4,4,5,5,6,6,7,7,8,8,9,9,10,10,10-heptadecafluorodecan-1-ol, 3,3,4,4,5,5,6,6,7,7,8,8,9,9,10,10,11,11,12,12,12-heneicosafluorododecan-1-ol, 3,3,4,4,5,5,6,6,7,7,8,8,9,9,10,10,11,11,12,12,13,13,14,14,14-pentacosafluorotetradecan-1-ol, 3,3,4,4,5,5,6,6,7,7,8,8,9,9,10,10,11,11,12,12,13,13,14,14,15,15,16,16,16-nonacosafluorohexadecan-1-ol, 3,3,4,4,5,5,6,6,7,7,8,8-dodecafluoroheptan-1-ol, 3,3,4,4,5,5,6,6,7,7,8,8,9,9,10,10-hexadecafluorononan-1-ol, 3,3,4,4,5,5,6,6,7,7,8,8,9,9,10,10,11,11,12,12-eicosafluoroundecan-1-ol, 3,3,4,4,5,5,6,6,7,7,8,8,9,9,10,10,11,11,12,12,13,13,14,14-tetracosafluorotridecan-1-ol, 3,3,4,4,5,5,6,6,7,7,8,8,9,9,10,10,11,11,12,12,13,13,14,14,15,15,16,16-octacosafluoropentadecan-1-ol, the commercial products Fluowet® EA 600, Fluowet® EA 800, Fluowet® EA 093, Fluowet® EA 612, Fluowet® EA 612 N, Fluowet® EA 812 AC, Fluowet® EA 812 IW, Fluowet® EA 812 EP, Fluowet® EA 6/1020, comprising perfluoroalkylethanol mixtures, Fluowet® OTL, Fluowet® OTN, comprising ethoxylated perfluoroalkylethanol mixtures, from Clariant GmbH, the commercial products A-1620, A-1630, A-1660, A-1820, A-1830, A-1860, A-2020, A-3620, A-3820, A-5610, A-5810 from Daikin Industries, Ltd., the commercial products Zonyl® BA, Zonyl® BA L, Zonyl® BA LD, comprising perfluoroalkylethanol mixtures, Zonyl® OTL, Zonyl® OTN, comprising ethoxylated perfluoroalkylethanol mixtures, Zonyl® FSH, Zonyl® FSO, Zonyl® FSN, Zonyl® FS-300, Zonyl® FSN-100, Zonyi® FSO-100 from DuPont de Nemours, the commercial products Krytox® from DuPont de Nemours, comprising hexafluoropropene oxide (HFPO) oligomer alcohol mixtures, or suitable combinations thereof. Preference is given to using perfluoroalkylethanol mixtures comprising 30-49.9% by weight of 3,3,4,4,5,5,6,6,7,7,8,8,8-tridecafluorooctan-1-ol and 30-49.9% by weight of 3,3,4,4,5,5,6,6,7,7,8,8,9,9,10,10,10-heptadecafluorodecan-1-ol, e.g. the commercial products Fluowet® EA 612 and Fluowet® EA 812.

Suitable (per)fluoroalkylalkylenamine components (B)(ii) are, for example, 3,3,4,4,5,5,6,6,7,7,8,8,8-tridecafluorooctylamine, 3,3,4,4,5,5,6,6,7,7,8,8,9,9,10,10,10-heptadecafluorodecylamine, 3,3,4,4,5,5,6,6,7,7,8,8,9,9,10,10,11,11,12,12,12-heneicosafluorododecylamine, 3,3,4,4,5,5,6,6,7,7,8,8,9,9,10,10,11,11,12,12,13,13,14,14,14-pentacosafluorotetradecylamine, 3,3,4,4,5,5,6,6,7,7,8,8,9,9,10,10,11,11,12,12,13,13,14,14,15,15,16,16,16-nonacosafluorohexadecylamine, reaction products of 1,1,1,2,2,3,3,4,4,5,5,6,6-tridecafluoro-8-iodooctane, 1,1,1-2,2,3,3,4,4,5,5,6,6,7,7,8,8-heptadecafluoro-10-iododecane, 1,1,1,2,2,3,3,4,4,5,5,6,6,7,7,8,8,9,9,10,10-heneicosafluoro-12-iodododecane, 1,1,1,2,2,3,3,4,4,5,5,6,6,7,7,8,8,9,9,10,10,11,11,12,12-pentacosafluoro-14-iodotetradecane, 1,1,1,2,2,3,3,4,4,5,5,6,6,7,7,8,8,9,9,10,10,11,11,12,12,13,13,14,14-nonacosafluoro-16-iodohexadecane, the commercial products Fluowet® 1600, Fluowet® 1800, Fluowet® 1612, Fluowet® 1812, Fluowet® 16/1020, Fluowet® 11020, comprising perfluoroalkyl iodide mixtures, Fluowet® EI 600, Fluowet® EI 800, Fluowet® EI 812, Fluowet® EI 6/1020, comprising perfluoroalkylethyl iodide mixtures, from Clariant GmbH and suitable amination reagents, the commercial products U-1610, U-1710, U-1810 from Daikin Industries, Ltd., or suitable combinations thereof. Preference is given to using perfluoroalkylethanol mixtures comprising 30-49.9% by weight of 3,3,4,4,5,5,6,6,7,7,8,8,8-tridecafluorooctylamine and 30-49.9% by weight of 3,3,4,4,5,5,6,6,7,7,8,8,9,9,10,10,10-heptadecafluorodecylamine.

As suitable fluorine-modified macromonomers or telechelic polymers (B)(iii), it is possible to use, for example, 4-(3,3,4,4,5,5,6,6,7,7,8,8,8-tridecafluorooctyl)benzyl alcohol, 4-(3,3,4,4,5,5,6,6,7,7,8,8,9,9,10,10,10-heptadecafluorodecyl)benzyl alcohol, 4-(3,3,4,4,5,5,6,6,7,7,8,8,8-tridecafluorooctylthio)phenol, 4-(3,3,4,4,5,5,6,6,7,7,8,8,9,9,10,10,10-heptadecafluorodecylthio)phenol, 4-(4,4,5,5,6,6,7,7,8,8,9,9,9-tridecafluorononyloxy)benzyl alcohol, 4-(4,4,5,5,6,6,7,7,8,8,9,9,10,10,11,11,11-heptadecafluoroundecyloxy)benzyl alcohol, 4-(3,3,4,4,5,5,6,6,7,7,8,8,8-tridecafluorooctyl)benzylamine, 4-(3,3,4,4,5,5,6,6,7,7,8,8,9,9,10,10,10-heptadecafluorodecyl)benzylamine, 3,3,4,4,5,5,6,6,7,7,8,8,8-tridecafluorooctane-1-thiol, 3,3,4,4,5,5,6,6,7,7,8,8,9,9,10,10,10-heptadecafluorodecane-1-thiol, 3,3,4,4,5,5,6,6,7,7,8,8,9,9,10,10,11,11,12,12,12-heneicosafluorododecane-1-thiol, 3,3,4,4,5,5,6,6,7,7,8,8,9,9,10,10,11,11,12,12,13,13,14,14,14-pentacosafluorotetradecane-1-thiol, 3,3,4,4,5,5,6,6,7,7,8,8,9,9,10,10,11,11,12,12,13,13,14,14,15,15,16,16,16-nonacosafluorohexadecane-1-thiol, hydroxyl-functional copolymers based on tetrafluoroethylene and hydroxyalkyl(meth)acrylates, e.g. the commercial products Zeffle® GK-500, GK-510, GK 550 from Daikin Industries, Ltd., or suitable combinations thereof.

3,3,4,4,5,5,6,6,7,7,8,8,8-Tridecafluoro-1-isocyanatooctane 3,3,4,4,5,5,6,6,7,7,8,8,9,9,10,10,10-heptadecafluoro-1-isocyanatodecane, 3,3,4,4,5,5,6,6,7,7,8,8,9,9,10,10,11,11,12,12,12-heneicosafluoro-1-isocyanatododecane, 3,3,4,4,5,5,6,6,7,7,8,8,9,9,10,10,11,11,12,12,13,13,14,14,14-pentacosafluoro-1-isocyanatotetradecane, 3,3,4,4,5,5,6,6,7,7,8,8,9,9,10,10,11,11,12,12,13,13,14,14,15,15,16,16,16-nonacosafluoro-1-isocyanatohexadecane or suitable combinations thereof are typical representatives of the (per)fluoroalkylalkylene isocyanate component (B)(iv).

Suitable (per)fluoroalkylalkanecarboxylic acid derivative components (B)(v) are, for example, tridecafluoroheptanoic acid, pentadecafluorooctanoic acid, heptadecafluorononanoic acid, nonadecafluorodecanoic acid, heneicosafluoroundecanoic acid, the commercial products C-1600, C-1700, C-1800, C-1900, C-2000, C-5600, C-5800 from Daikin Industries, Ltd., tridecafluoroheptanoyl chloride, pentadecafluorooctanoyl chloride, heptadecafluorononanoyl chloride, nonadecafluorodecanoyl chloride, heneicosafluoroundecanoyl chloride, (m)ethyl tridecafluoroheptanoate, (m)ethyl pentadecafluorooctanoate, (m)ethyl heptadecafluorononanoate, (m)ethyl nonadecafluorodecanoate, (m)ethyl heneicosafluoroundecanoate, the commercial products C-1708, C-5608, C-5808, S-1701, S-1702, S-5602, S-5802 from Daikin Industries, Ltd., or suitable combinations thereof.

As suitable isocyanatoalkylalkoxysilane component (C)(i) and/or other isocyanatosilane component (C)(ii), it is possible to use, for example, the commercial products Silquest® A-1310 Silane, Silquest® A-Link™ 25 Silane (3-isocyanatopropyltriethoxysilane), Silquest® A-Link™ 35 Silane ((3-isocyanatopropyl)trimethoxysilane), Silquest® A-Link™ 597 Silane, Silquest® FR-522 Silane and Silquest® Y-5187 Silane from GE Silicones, the commercial products GENIOSIL® GF 40 (3-isocyanatopropyltrimethoxysilane), GENIOSIL® XL 42 (isocyanatomethylmethyldimethoxysilane) and GENIOSIL® XL 43 (isocyanatomethyltrimethoxysilane) from Wacker-Chemie GmbH or suitable combinations thereof. For the purposes of the present invention, preference is given to 3-isocyanatopropyltrimethoxysilane and/or 3-isocyanatopropyltriethoxysilane.

Compounds suitable as polyisocyanate component (D)(i) and/or other polyisocyanate component (D)(ii) are, for example, polyisocyanates, polyisocyanate derivatives or polyisocyanate homologues having two or more aliphatic or aromatic isocyanate groups of identical or different reactivity or suitable combinations thereof, in particular also the polyisocyanates which are adequately known in polyurethane chemistry or combinations thereof. Suitable aliphatic polyisocyanates are, for example, 1,6-diisocyanatohexane (HDI), 1-isocyanato-5-isocyanatomethyl-3,3,5-trimethylcyclohexane or isophorone diisocyanate (IPDI, commercial product VESTANAT® IPDI from Degussa AG), bis(4-isocyanatocyclohexyl)methane (H₁₂MDI, commercial product VESTANAT® H12MDI from Degussa AG), 1,3-bis(1-isocyanato-1-methylethyl)benzene (m-TMXDI), 2,2,4-trimethyl-1,6-diisocyanatohexane or 2,4,4-trimethyl-1,6-diisocyanatohexane (TMDI, commercial product VESTANAT® TMDI from Degussa AG), diisocyanates based on dimeric fatty acids (commercial product DDI® 1410 DIISOCYANATE from Cognis Deutschland GmbH & Co. KG) or industrial isomer mixtures of the individual aliphatic polyisocyanates. As suitable aromatic polyisocyanates, it is possible to use, for example, 2,4-diisocyanatotoluene or tolylene diisocyanate (TDI), bis(4-isocyanatophenyl)methane (MDI) and its higher homologues (polymeric MDI) or industrial isomer mixtures of the individual aromatic polyisocyanates. Furthermore, the “surface coating polyisocyanates” based on bis(4-isocyanatocyclohexyl)methane (H₁₂MDI), 1,6-diisocyanatohexane (HDI), 1-isocyanato-5-isocyanatomethyl-3,3,5-trimethylcyclohexane (IPDI) are also suitable in principle. The term “surface coating polyisocyanates” refers to derivatives of these isocyanates which have allophanate, biuret, carbodiimide, iminooxadiazinedione, isocyanurate, oxadiazinetrione, uretdione, urethane groups and in which the residual content of monomeric diisocyanates has been reduced to a minimum, as per the prior art. In addition, it is also possible to use modified polyisocyanates which can be obtained, for example, by hydrophilic modification of bis(4-isocyanatocyclo-hexyl)methane (H₁₂MDI), 1,6-diisocyanatohexane (HDI), 1-isocyanato-5-isocyanatomethyl-3,3,5-trimethylcyclohexane (IPDI) by means of monohydroxy-functional polyethylene glycols or aminosulphonic acid sodium salts. As suitable “surface coating polyisocyanates”, it is possible to use, for example, the commercial products VESTANAT® T 1890 E, VESTANAT® T 1890 L, VESTANAT® T 1890 M, VESTANAT® T 1890 SV, VESTANAT® T 1890/100 (polyisocyanates based on IPDI trimer), VESTANAT® HB 2640 MX, VESTANAT® HB 2640/100, VESTANAT® HB 2640/LV (polyisocyanates based on HDI-biuret), VESTANAT® HT 2500 L, VESTANAT® HB 2500/100, VESTANAT® HB 2500/LV (polyisocyanates based on HDI-isocyanurate) from Degussa AG, the commercial product Basonat® HW 100 from BASF AG, the commercial products Bayhydur® 3100, Bayhydur® VP LS 2150 BA, Bayhydur® VP LS 2306, Bayhydur® VP LS 2319, Bayhydur® VP LS 2336, Bayhydur® XP 2451, Bayhydur® XP 2487, Bayhydur® XP 2487/1, Bayhydur® XP 2547, Bayhydur® XP 2570, Desmodur® XP 2565 from Bayer AG and also the commercial products Rhodocoat® X EZ-M 501, Rhodocoat® X EZ-M 502, Rhodocoat® WT 2102 from Rhodia. According to the invention, preference is given to using isophorone diisocyanate and/or tolylene diisocyanate as component (D)(i) and a (optionally hydrophilically modified) trimer of 1,6-diisocyanatohexane as component (D)(ii). In the case of the reaction products a₇), a₈), a₁₁), a₁₂), c₁₂) and c_{1.14}), it is also possible to use hydrophilically modified polyisocyanates; when polyisocyanates modified by means of monohydroxy-functional polyethylene glycols are used, the use of the monofunctional polyalkylene glycol component (G)(i) and/or the monofunctional polyoxyalkylenamine component (G)(ii) can be omitted in the case of the reaction products a₈) and c_{1.14}).

Examples of suitable aminoalkylalkoxysilane components (E)(i) and/or other aminosilane components (E)(ii) are the commercial products DYNASILAN® AMMO (3-aminopropyltrimethoxysilane), DYNASILAN® AMEO (AMEO-P) (3-aminopropyltriethoxysilane), DYNASILAN® AMEO-T (proprietary aminosilane combination), DYNASILAN® DAMO (DAMO-P) (N-(2-aminoethyl)-3-aminopropyltrimethoxysilane), DYNASILAN® DAMO-T (proprietary aminosilane combination), DYNASILAN® TRIAMO (N—[N′-(2-aminoethyl)-2-aminoethyl]-3-aminopropyltrimethoxysilane), DYNASILAN® 1122 (bis(3-triethoxysilylpropyl)amine), DYNASILAN® 1126 (proprietary aminosilane combination), DYNASILAN® 1146 (diamino/alkyl-functional siloxane cooligomer), DYNASILAN® 1189 (N-butyl-3-aminopropyltrimethoxysilane), DYNASILAN® 1204 (proprietary aminosilane combination), DYNASILAN® 1411 (N-(2-aminoethyl)-3-aminopropylmethyldimethoxysilane), DYNASILAN® 1505 (3-aminopropylmethyldiethoxysilane), DYNASILAN® 1506 (3-aminopropylmethyldiethoxysilane preparation in solvent), DYNASILAN® 2201 (3-ureidopropyltriethoxysilane, 50% in methanol) from Degussa AG, the commercial products Silquest® A-1100 Silane, Silquest® A-1101 Silane, Silquest® A-1102 Silane, Silquest® A-1106 Silane, Silquest® A-1110 Silane, Silquest® A-1120 Silane, Silquest® A-1130 Silane, Silquest® A-1160 Silane, Silquest® A-1170 Silane, Silquest® A-1637 Silane, Silquest® A-2120 Silane, Silquest® A-2639 Silane, Silquest® A-Link™ 15 Silane, Silquest® Y-9669 Silane from GE Silicones and the commercial products GENIOSIL® GF 9 (N-2-aminoethyl-3-aminopropyltrimethoxysilane), GENIOSIL® GF 91 (N-2-aminoethyl-3-aminopropyltrimethoxysilane), GENIOSIL® GF 93 (3-aminopropyltriethoxysilane), GENIOSIL® GF 95 (N-2-aminoethyl-3-aminopropylmethyldimethoxysilane), GENIOSIL® GF 96 (3-aminopropyltrimethoxysilane), GENIOSIL® XL 924 (N-cyclohexylaminomethylmethyldiethoxysilane), GENIOSIL® XL 926 (N-cyclohexylaminomethyltriethoxysilane), GENIOSIL® XL 972 (N-phenylaminomethylmethyldimethoxysilane), GENIOSIL® XL 973 (N-phenylaminomethyltrimethoxysilane) from Wacker Chemie GmbH or suitable combinations thereof. For the purposes of the present invention, preferred components (E)(i) are 3-aminopropyltrimethoxysilane and/or 3-aminopropyltriethoxysilane and/or N-(2-aminoethyl)-3-aminopropyltrimethoxysilane and/or N-(2-aminoethyl)-3-aminopropyltriethoxysilane and/or N—[N′-(2-aminoethyl)-2-aminoethyl]-3-aminopropyltrimethoxysilane.

As suitable nonionic silane component (E)(iii), it is possible to use, for example, the commercial products DYNASILAN® 4140 (4140-A) (trimethoxysilylpropylmethylpolyethylene glycol), DYNASILAN® 1211 (polyglycol ether-modified aminosilane) from Degussa AG, the commercial product Silquest®A-1230 Silane (trimethoxysilylpropylmethylpolyethylene glycol) from GE Silicones or suitable combinations thereof, with silanes of the general formula

H₃C—O—(CH₂CH₂—O)_{z},—(CH₂)₃—Si(OR¹)₃,

where z′=5-15 and R¹=Me, Et, being particularly suitable as components E(iii).

As suitable aminosilicone oil component (E)(iv), it is possible to use, for example, the commercial products AO 201, AO 202, AO 1000, AO 1001, AO 1002, AO 4000, AO 4001, AO 4500, AO 6500, comprising aminosilicone oils or hydroxy- and/or alkoxy-terminated poly[3-((2-aminoethyl)amino)propyl]methyl(dimethyl)siloxane, from Nitrochemie Aschau GmbH or suitable combinations thereof.

The commercial products DYNASILAN® MTMS (methyltrimethoxysilane), DYNASILAN® MTES (methyltriethoxysilane), DYNASILAN® PTMO (propyltrimethoxysilane), DYNASILAN® PTEO (propyltriethoxysilane), DYNASILAN® IBTMO (isobutyltrimethoxysilane), DYNASILAN® IBTEO (isobutyltriethoxysilane), DYNASILAN® OCTMO (octyltrimethoxysilane), DYNASILAN® OCTEO (octyltriethoxysilane), DYNASILAN® 9116 (hexadecyltrimethoxysilane), DYNASILAN® 9165 (phenyltrimethoxysilane, formerly CP 0330), DYNASILAN® 9265 (phenyl)triethoxysilane, formerly CP 0320), DYNASILAN® A (tetraethylorthosilicate) DYNASILAN® A SQ (tetraethylorthosilicate, high purity), DYNASILAN® M (tetramethylorthosilicate), DYNASILAN® P (tetra-n-propylsilicate), DYNASILAN® BG (tetrabutylglycol silicate) DYNASILAN® 40 (ethylpolysilicate) from Degussa AG or suitable combinations thereof are suitable low molecular weight silane components (E)(v).

Particularly suitable hydrophilicized aqueous silane components (E)(vi) are, for example, the commercial products DYNASILAN® 1161 (cationic, benzylamino-functional silane, hydrochloride, 50% by weight in methanol), DYNASILAN® 1172 (cationic, benzylamino-functional silane, hydroacetate, 50% by weight in methanol), DYNASILAN® 1151 (aminosilane hydrolysate, alcohol-free), DYNASILAN® HS 2627 (HYDROSIL® 2627) (amino/alkyl-functional siloxane cooligomer, alcohol-free), DYNASILAN® HS 2775 (HYDROSIL® 2775) (triamino/alkyl-functional siloxane cooligomer, alcohol-free), DYNASILAN® HS 2776 (HYDROSIL® 2776, alcohol-free) (diamino/alkyl-functional siloxane cooligomer), DYNASILAN® HS 2781 (HYDROSIL® 2781) (amino/vinyl-functional siloxane cooligomer, alcohol-free), DYNASILAN® HS 2907 (HYDROSIL® 2907) (amino/vinyl-functional siloxane cooligomer, alcohol-free), DYNASILAN® HS 2909 (HYDROSIL® 2909) (amino/alkyl-functional siloxane cooligomer, alcohol-free), DYNASILAN® HS 2926 (HYDROSIL® 2926) (epoxy-functional siloxane cooligomer, alcohol-free) from Degussa AG or suitable combinations thereof.

Suitable representatives of monofunctional hexafluoropropene oxide components (F)(i) are, for example, monofunctional polyhexafluoropropene oxide carboxylic acids, polyhexafluoropropene oxide carboxylic fluorides, methyl esters of polyhexafluoropropene oxide carboxylic acids from Dyneon GmbH & Co. KG or suitable combinations thereof.

As suitable bifunctional hexafluoropropene oxide component (F)(ii), it is possible to use, for example, bifunctional polyhexafluoropropene oxide carboxylic acids, polyhexafluoropropene oxide carboxylic fluorides, methyl esters of polyhexafluoropropene oxide carboxylic acids from Dyneon GmbH & Co. KG or suitable combinations thereof.

The commercial products M 250, M 350, M 350 PU, M 500, M 500 PU, M 750, M 1100, M 2000 S, M 2000 FL, M 5000 S, M 5000 FL, comprising monofunctional methylpolyethylene glycol, B11/50, B11/70, B11/100, B11/150, B11/150 K, B11/300, B11/700, comprising monofunctional butylpoly(ethylene oxide-ran-propylene oxide), from Clariant GmbH and the commercial product LA-B 729, comprising monofunctional methylpoly(ethylene oxide-block/co-propylene oxide) from Degussa AG or suitable combinations thereof are suitable monofunctional polyalkylene glycol components (G)(i).

Suitable monofunctional polyoxyalkylenamine components (G)(ii) are, for example, the commercial products JEFFAMINE® XTJ-505 (M-600), JEFFAMINE® XTJ-506 (M-1000), JEFFAMINE® XTJ-507 (M-2005), JEFFAMINE® M-2070, comprising monofunctional polyoxyalkylenamine based on ethylene oxide and propylene oxide, from Huntsman Corporation or suitable combinations thereof.

Typical representatives of the polyfunctional polyalkylene glycol component (G)(iii) are, for example, the commercial products 200, 200 G, 300, 300 G, 400, 400 G, 600, 600 A, 600 PU, 900, 1000, 1000 WA, 1500 S, 1500 FL, 1500 PS, 2000 S, 2000 FL, 3000 S, 3000 P, 3000 FL, 3350 S, 3350 P, 3350 FL, 3350 PS, 3350 PT, 4000 S, 4000 P, 4000 FL, 4000 PS, 4000 PF, 5000 FL, 6000 S, 6000 P, 6000 PS, 6000 FL, 6000 PF, 8000 S, 8000 P, 8000 FL, 8000 PF, 10000 S, 10000 P, 12000 S, 12000 P, 20000 S, 20000 P, 20000 SR, 20000 SRU, 35000 S, comprising bifunctional polyethylene glycol, PR 300, PR 450, PR 600, PR 1000, PR 1000 PU, VPO 1962, comprising bifunctional poly(ethylene oxide-block-propylene oxide-block-ethylene oxide), D21/150, D21/300, D21/700, comprising bifunctional poly(ethylene oxide-ran-propylene oxide) and P41/200 K, P41/300, P41/3000, P41/120000, comprising tetrafunctional poly(ethylene oxide-ran-propylene oxide), from Clariant or suitable combinations thereof.

As polyfunctional polyoxyalkylenamine component (G)(iv), it is possible to use, for example, the commercial products JEFFAMINE® HK-511 (XTJ-511); JEFFAMINE® XTJ-500 (ED-600), JEFFAMINE® XTJ-502 (ED-2003), comprising bifunctional polyoxyalkylenamine based on ethylene oxide and propylene oxide, from Huntsman Corporation or suitable combinations thereof.

Cyanuric chloride or 2,4,6-trichloro-1,3,5-triazine from Degussa AG are suitable triazine components (H).

As hydroxycarboxylic acid component (I), it is possible to use, for example, 2-hydroxymethyl-3-hydroxypropanoic acid or dimethylolacetic acid, 2-hydroxymethyl-2-methyl-3-hydroxypropanoic acid or dimethylolpropionic acid, 2-hydroxymethyl-2-ethyl-3-hydroxypropanoic acid or dimethylolbutyric acid, 2-hydroxymethyl-2-propyl-3-hydroxypropanoic acid or dimethylolvaleric acid, hydroxypivalic acid (HPA), citric acid, tartaric acid or suitable combinations thereof. According to the invention, preference is given to using citric acid and/or hydroxypivalic acid and/or dimethylolpropionic acid. If necessary, amino- and, if appropriate, hydro-functional carboxylic acids such as 2-hydroxyethanoic acid or amino- and/or hydro-functional sulphonic acids such as 2-aminoethanoic acid, tris(hydroxymethyl)methyl-3-aminopropanesulphonic acid can also be used.

As NCN component (J), it is possible to use, for example, cyanamide from Degussa AG.

As regards carbonyl component (K), suitable examples are phosgene, diphosgene, triphosgene, aliphatic and/or aromatic chloroformic esters such as methyl chloroformate, ethyl chloroformate, isopropyl chloroformate, phenyl chloroformate, aliphatic and/or aromatic carbonic esters such as dimethyl carbonate, diethyl carbonate, diisopropyl carbonate, diphenyl carbonate or suitable combinations thereof. For the purposes of the present invention, preference is given to using phosgene and/or ethyl chloroformate and/or diethyl carbonate. Further suitable carbonyl components (A₈) which can be used are, for example, preformed adducts of the component (K) and the components (B)(i) and/or (B)(ii) and/or (B)(iii) or preformed adducts of the component (K) and the components (E)(i) and/or (E)(ii), e.g. the commercial product GENIOSIL® XL 63 (N-(trimethoxysilylmethyl)-β-methylcarbamate from Wacker-Chemie GmbH, N-(triethoxysilylmethyl)-β-methylcarbamate, N-(trimethoxysilylmethyl)-O-ethylcarbamate, N-(triethoxysilylmethyl)-O-ethylcarbamate, N-(trimethoxysilylpropyl)-O-methylcarbamate, N-(triethoxysilylpropyl)-O-methylcarbamate, N-(trimethoxysilylpropyl)-O-ethylcarbamate, N-(triethoxysilylpropyl)-β-ethylcarbamate or suitable combinations thereof. Preference is given to using chloroformates or phosgene derivatives of the components (B)(i) and/or (B)(ii) and/or (B)(iii) and/or carbamates of the components (E)(i) and/or (E)(ii).

Suitable mercaptoalkylalkoxysilane components (L)(i) and/or other mercaptosilane components (L)(ii) are, for example, the commercial products DYNASILAN® MTMO (3-mercaptopropyltrimethoxysilane), DYNASILAN® MTEO (3-mercaptopropyltriethoxysilane) from Degussa AG or suitable combinations thereof. Preference is given to using 3-mercaptopropyltrimethoxysilane and/or 3-mercaptopropyltriethoxysilane.

As suitable (per)fluoroalkylalkylene oxide component (M), it is possible to use, for example, 4,4,5,5,6,6,7,7,8,8,9,9,9-tridecafluorononene 1,2-oxide, 4,4,5,5,6,6,7,7,8,8,9,9,10,10,11,11,11-heptadecafluoroundecene 1,2-oxide, 4,4,5,5,6,6,7,7,8,8,9,9,10,10,11,11,12,12,13,13,13-heneicosafluorotridecene 1,2-oxide, glycidyl 2,2,3,3,4,4,5,5,6,6,7,7-dodecafluoroheptyl ether, glycidyl 2,2,3,3,4,4,5,5,6,6,7,7,8,8,9,9-hexadecafluorononyl ether, glycidyl 2,2,3,3,4,4,5,5,6,6,7,7,8,8,9,9,10,10,11,11-eicosafluoroundecyl ether, the commercial products E-1830, E-2030, E-3630, E-3830, E-5644, E-5844 from Daikin Industries, Ltd. or suitable combinations thereof. Particularly preferred compounds are 4,4,5,5,6,6,7,7,8,8,9,9,9-tridecafluorononene 1,2-oxide and/or 4,4,5,5,6,6,7,7,8,8,9,9,10,10,11,11,11-heptadecafluoroundecene 1,2-oxide.

Examples of suitable epoxyalkylolalkoxysilane components (N)(i) and/or other epoxysilane components (N)(ii) are the commercial products DYNASILAN® GLYMO ((3-glycidyloxypropyl)trimethoxysilane), DYNASILAN® GLYEO ((3-glycidyloxypropyl)triethoxysilane) from Degussa AG, the commercial products CoatOSil® 1770, Silquest® A-187 Silane, Silquest® A-186 Silane, Silquest® WetLink 78 Silane from GE Silicones, the commercial products GENIOSIL® GE 80 ((3-glycidyloxypropyl)trimethoxysilane), GENIOSIL® GF 82 ((3-glycidyloxypropyl)triethoxysilane) from Wacker-Chemie GmbH or suitable combinations thereof, with 3-glycidyloxypropyltrimethoxysilane and/or 3-glycidyloxypropyltriethoxysilane being particularly suitable.

Suitable polyamine components (O) are, for example, adipic acid dihydrazide, ethylenediamine, diethylenetriamine, triethylenetetramine, tetraethylenepentamine, pentaethylenehexamine, dipropylenetriamine, hexamethylenediamine, hydrazine (hydrate), isophoronediamine, N-(2-aminoethyl)-2-aminoethanol, N,N′-bis(2-hydroxyethyl)ethylenediamine or suitable combinations thereof, with preference being given to ethylenediamine.

As suitable polyhedral oligomeric polysilasesquioxane components (P)(i) and/or (P)(ii) and/or (P)(iii), it is possible to use, for example, polysilasesquioxanes having one or more amino and/or hydroxyl and/or isocyanato and/or mercapto groups and one or more perfluoroalkyl groups of the general formula

(R⁸ᵤR⁹ᵥR¹⁰_{w}SiO_{1.5})₈
where 0<u<1, 0<v<1, 0<w<1, u+v+w=1,
   R⁸, R⁹, R¹⁰ independently of one another, any inorganic and/or organic and if appropriate polymeric radical having from 1 to 250 carbon atoms and from 0 to 50 N atoms and/or from 1 to 50 O atoms and/or from 3 to 100 F atoms and/or from 0 to 50 Si atoms and/or from 0 to 50 S atoms,
   and also the commercial products Creasil® from Degussa AG and the commercial products POSS® from Hybrid Plastics, Inc., or suitable combinations thereof.

For the purposes of the present invention, possible amino alcohol components (Q)(i) and/or other amino alcohol components (Q)(ii) are, for example, ethanolamine, N-methylethanolamine, diethanolamine, diisopropanolamine, 3-((2-hydroxyethyl)amino)-1-propanol, trimethylolmethylamine, amino sugars such as galactosamine, glucamine, glucosamine, neuramic acid or suitable combinations, with diethanolamine and/or diisopropanolamine and/or trimethylolmethylamine and/or amino sugars being particularly preferred compounds.

Suitable catalyst components (R) are, for example, dibutyltin oxide, dibutyltin dilaurate (DBTL), triethylamine, tin(II) octoate, 1,4-diazabicyclo[2.2.2]octane (DABCO), 1,4-diazabicyclo[3.2.0]-5-nonene (DBN), 1,5-diazabicyclo[5.4.0]-7-undecene (DBU), morpholine derivatives such as JEFFCAT®Amine Catalysts or suitable combinations thereof.

As regards the solvent component (S)(i), the present invention proposes low-boiling solvents such as acetone, butanone or high-boiling solvents such as N-methyl-2-pyrrolidone, N-ethyl-2-pyrrolidone, dipropylene glycol dimethyl ether (Proglyde DMM®) or suitable combinations thereof. The solvent component (S)(i) is inert towards isocyanate groups.

As solvent component (S)(ii), use is made of, for example, low-boiling solvents and preferably ethanol, methanol, 2-propanol or suitable combinations thereof.

Suitable stabilizing components (T) are, for example, anionic and/or cationic and/or nonionic hydrophilically modified and silane-modified reaction products which are usually prepared by a (poly)addition reaction and/or addition/elimination reactions.

Suitable acid components (U)(i) are, in particular, acrylic acid, methacrylic acid, maleic acid, fumaric acid, itaconic acid, 2-acrylamido-2-methylpropane-1-sulphonic acid (AMPS®) or suitable combinations thereof, with preference being given to acrylic acid.

As suitable acid component (U)(ii), it is possible to use, for example, acrylic anhydride, methacrylic anhydride, maleic anhydride, itaconic anhydride or suitable combinations thereof, with maleic anhydride being the preferred representative.

Suitable acid components (U)(iii) are γ- and/or δ-lactones of sugar acids or polyhydroxy(di)carboxylic acids or polyhydroxycarboxylic aldehydes, e.g. D-glucono-6-lactone, D-glucurono-δ-lactone, ascorbic acid, aldonic acid γ/δ-lactones, uronic acid γ/δ-lactones, D-glucaric acid γ/δ-lactones or suitable combinations thereof, with D-glucono-δ-lactone being preferred.

Formic acid is used as typical acid component (U)(iv). However, other monobasic or polybasic organic acids such as acetic acid, oxalic acid, malonic acid, citric acid, monobasic or polybasic inorganic acids such as amidosulphonic acid, hydrochloric acid, sulphuric acid, phosphoric acid or suitable combinations thereof are also suitable.

Polyalkylene glycol-modified and silane-modified reaction products which are prepared by (poly)addition reaction and/or addition/elimination reactions are suitable hydrophilic silane components (V).

For the purposes of the present invention, triethylamine is preferably used as neutralization component (W). However, tertiary amines in general, e.g. trimethylamine, N-methyldiethanolamine, N,N-dimethylethanolamine, triethanolamine, N-methylmorpholine, N-ethylmorpholine, inorganic bases such as ammonia, lithium hydroxide, sodium hydroxide, potassium hydroxide or suitable combinations thereof are likewise possible.

Suitable activator components (X) are, for example, water- and solvent-containing acids.

There are numerous representatives of suitable formulation components (Y)(i). (Functionalized) inorganic and/or organic fillers and/or lightweight fillers, (functionalized) inorganic and/or organic pigments, (functionalized) inorganic and/or organic support materials, inorganic and/or organic fibres, graphite, carbon black, carbon fibres, carbon nanotubes, metal fibres and powders, conductive organic polymers, further polymers and/or redispersible polymer powders, superabsorbents, further inorganic and/or organic compounds, antifoams, deaerators, lubricants and levelling additives, substrate wetting additives, wetting additives and dispersants, hydrophobicizing agents, rheological additives, coalescence auxiliaries, matting agents, bonding agents, antifreezes, antioxidants, UV stabilizers, biocides, water, solvents, catalysts or suitable combinations thereof are suitable for the purposes of the invention.

The (reactive) nanoparticle component (Y)(ii) according to the invention is represented by, for example, pyrogenic silica (SiO₂) such as AEROSIL® pyrogenic silicas, pyrogenic silcas doped with rare earths (RE), e.g. AEROSIL® pyrogenic silicas/RE-doped, silver-doped pyrogenic silicas such as AEROSIL® pyrogenic silicas/Ag-doped, silicon dioxide-aluminium oxide mixture (mullite) such as AEROSIL® pyrogenic silicas+Al₂O₃, silicon dioxide-titanium dioxide mixture such as AEROSIL® pyrogenic silicas+TiO₂, aluminium oxide (Al₂O₃) such as AEROXIDE® AluC, titanium dioxide (TiO₂) such as AEROXIDE® TiO₂ P25, zirconium dioxide (ZrO₂) VP Zirkonoxid PH, yttrium-stabilized zirconium dioxide such as VP Zirkonoxid 3YSZ, cerium dioxide (CeO₂) such as AdNano® Ceria, indium-tin oxide (ITO, In₂O₃/SnO₂) such as Adnano® ITO, nanosize iron oxide (Fe₂O₃) in a matrix of pyrogenic silica, e.g. AdNano® MagSilica, zinc oxide (ZnO) such as AdNano® Zinc Oxide from Degussa AG. Preference is given to using silicon dioxide and/or titanium dioxide and/or zinc oxide.

Nanoparticle dispersions can be produced by introducing nanoparticles into water or into dispersions (e.g. into polymer dispersions) by means of suitable dispersing apparatuses and a high energy input. Apparatuses suitable for this purpose are, in particular, dispersing apparatuses which effect a high energy input, e.g. high-speed stirrers, planetary kneaders, rotor-stator machines, ultrasonic apparatuses or high-pressure homogenizers; the Nanomizer® or Ultimizer (system) may be mentioned by way of example.

At least 50% by weight of the total (reactive) nanoparticle component (Y)(ii) has a particle size of not more than 500 nm (standard: DIN 53206-1, testing of pigments; particle size analysis, fundamentals) and the totality of particles having this particle size of not more than 500 nm have a specific surface area (standard: DIN 66131, determination of the specific surface area of solids by gas adsorption using the Brunauer, Emmet and Teller (BET) method) of from 10 to 200 m²/g.

Likewise, at least 70% by weight and preferably at least 90% by weight of the total (reactive) nanoparticle component (Y)(ii) has a particle size of from 10 to 300 nm (standard: DIN 53206-1, testing of pigments; particle size analysis, fundamentals), and the totality of particles having this particle size of from 10 to 300 nm should, according to the invention, have a specific surface area (standard: DIN 66131, determination of the surface area of solids by gas adsorption using the Brunauer, Emmet and Teller (BET) method) of from 30 to 100 m²/g.

The formulation component (Y)(i) and the (reactive) nanoparticle component (Y)(ii) can, according to the present invention, be present in coated and/or microencapsulated and/or supported and/or hydrophilicized and/or solvent-containing form and be liberated, if appropriate, in a retarded manner.

As suitable functionalization component (Z), it is possible to use, for example, functionalized silanes and/or siloxanes and nanoparticles.

The present invention further provides a process for producing the fluorine-containing compositions of the invention. In this process,

a) a fluorosilane component (A)(i) is produced by reacting the components
a1) (B)(i), (B)(ii), (B)(iii) and (C) and/or
a₂) (B)(i), (B)(ii), (B)(iii), (D)(i), (E)(i) and (E)(ii) and/or
a₃) (B)(iv), (E)(i) and (E)(ii) and/or
a₄) (B)(v), (E)(i) and (E)(ii) and/or
a₅) (F)(i), (E)(i) and (E)(ii) and/or
a₆) (F)(ii), (E)(i) and (E)(ii) and/or
a₇) (B)(i), (B)(ii), (B)(iii), (E)(i), (E)(ii) and (D)(ii) and/or
a₈) (B)(i), (B)(ii), (B)(iii), (E)(i), (E)(ii), (G)(i), (G)(ii) and (D)(ii) and/or
a₉) (B)(i), (B)(ii), (B)(iii), (E)(i), (E)(ii) and (H) and/or
a₁₀) (B)(i), (B)(ii), (B)(iii), (E)(i), (E)(ii), (G)(i), (G)(ii) and (H) and/or
a₁₁) (B)(i), (B)(ii), (B)(iii), (E)(i), (E)(ii), (G)(iii), (G)(iv) and (D)(i) and/or
a₁₂) (B)(i), (B)(ii), (B)(iii), (E)(i), (E)(ii), (I) and (D)(ii) and/or
a₁₃) (B)(i), (B)(ii), (B)(iii), (E)(i), (E)(ii), (J) and (D)(ii) and/or
a₁₄) (B)(i), (B)(ii), (B)(iii), (E)(i), (E)(ii) and (K) and/or
a₁₅) as per a₂) to a₁₄) with the components (E)(i) and E(ii) being replaced by the components (L)(i) and (L)(ii) and/or
a₁₆) (M), (E)(i) and (E)(ii) and/or
a₁₇) (M), (N)(i), (N)(ii) and (O) and/or
a₁₈) (P)(i), (E)(i) and (E)(ii) and/or
a₁₉) (P)(ii), (C)(i) and (C)(ii) and/or
a₂₀) (P)(iii), (Q)(i) and (Q)(ii)
or, as an alternative according to a₂₁) to a₂₂), preformed fluorosilanes (A)(ii) are used,
where, if appropriate, a catalyst component (R) and, if appropriate, a solvent component (S)(i) is/are present in addition to the pure fluorosilane component (A); and subsequently
b₁) if appropriate, the solvent component (S)(i) from step a) is partially or completely removed by distillation before, during or after the reaction,
b₂) if appropriate, the catalyst component (R) from step a) is partially or completely removed by means of suitable absorption materials or other measures after the reaction,
b₃) if appropriate, the fluorosilane component (A) from step a) is dissolved in the solvent component (S)(ii) before, during or after the reaction,
   or
c₁) the fluorosilane component (A) from step a) or b), if appropriate in the presence of an aminoalkylalkoxysilane component (E)(i) and/or an aminosilane component (E)(ii) and/or a stabilizing component (T) comprising reaction products of the components
   c_{1.1}) (Q)(i), (Q)(ii), (C)(i) and (C)(ii) and/or
   c_{1.2}) (Q)(i) (Q)(ii), (E)(i), (E)(ii) and (D)(i) and/or
   c_{1.3}) (I), (C)(i) and (C)(ii) and/or
   c_{1.4}) (I), (E)(i), (E)(ii) and (D)(i) and/or
   c_{1.5}) (J), (C)(i) and (C)(ii) and/or
   c_{1.6}) (J), (E)(i), (E)(ii) and (D)(i) and/or
   c_{1.7}) (E)(i), (E)(ii) and (U)(i) and/or
   c_{1.8}) (E)(i), (E)(ii) and (U)(ii) and/or
   c_{1.9}) (E)(i), (E)(ii) and (U)(iii),
   where, if appropriate, a catalyst component (R), if appropriate a solvent
   component (S)(i) and, if appropriate, a solvent component (S)(ii) are present in addition to the pure stabilizing component (T),
   and a hydrophilic silane component (V) comprising
   c_{1.10}) (E)(iii) and/or reaction products of the components
   c_{1.11}) (G)(i), (G)(ii), (G)(iii), (G)(iv), (C)(i) and (C)(ii) and/or
   c_{1.12}) (G)(i) and (G)(ii) (G)(iii) (G)(iv), (E)(i) (E)(ii) and (D)(i) and/or
   c_{1.13}) (G)(ii), (G)(iv), (N)(i) and (N)(ii) and/or
   c_{1.14}) (G)(i), (G)(ii), (E)(i), (E)(ii) and (D)(ii) and/or
   c_{1.15}) (G)(i), (G)(ii), (E)(i), (E)(ii) and (H),
   where, if appropriate, a catalyst component (R), if appropriate a solvent component (S)(i) and, if appropriate, a solvent component (S)(ii) are present in addition to the pure hydrophilic silane component (V),
   are (partially) hydrolysed or silanolized by means of water,
c₂) the (amino-functional) adduct is partially or completely neutralized by means of acid component (U)(iv) or another neutralization component (W),
c₃) if appropriate, the liberated alcohol and/or the solvent components (S)(i) and/or (S)(ii) is/are partially or completely removed by distillation before, during or after the reaction,
d₁) the reaction product from step c) is subsequently or simultaneously dissolved or dispersed and oligomerized in water,
d₂) if appropriate, the liberated alcohol and/or the solvent components (S)(i) and/or (S)(ii) is/are partially or completely removed by distillation before, during or after the reaction and, if appropriate, the catalyst component (R) is partially or completely removed by means of suitable absorption materials or other measures before, during or after the reaction so that not more than from 0 to 1 part by weight of a catalyst component (R), from 0 to 25 parts by weight of a solvent component (S)(i) and from 0 to 25 parts by weight of a solvent component (S)(ii) are present.
If appropriate, f) a formulation component (Y)(i) can be added and/or a functionalization component (Z) comprising the components
   e₁) (E)(iv) and/or
   e₂) (E)(v) and/or
   e₃) (E)(vi) and/or
   e₄) (Y)(ii),
   can be added and/or coreacted during or after steps a) and/or b) and/or c) and/or d).

In a further process variant, the components (A)(i) from reaction step a) and (V) from reaction step c) can be prepared or blended simultaneously. Furthermore, the reaction steps c) and d) or b), c) and d) can, according to the invention, be combined in any way and order.

It is also possible, in step b₃), for a (partial) transesterification of the alkoxysilane groups of the fluorosilane component (A) with an alcoholic solvent component (S)(ii) to be additionally carried out.

In addition, it can be advantageous to remove the liberated alcohol and/or the solvent components (S)(i) and/or (S)(ii) by (azeotropic) distillation in steps c₃) and d₂) and, if appropriate, subsequently or simultaneously replace the water removed.

In step c), the acid component (U)(iv) can be initially charged together with the water.

The present invention likewise encompasses using the fluorine-containing compositions or (per)fluoroalkyl-functional organosilanes as per reaction steps a) and b) likewise in single-component form like the fluorine-containing compositions or (per)fluoroalkyl-functional organopolysiloxane precondensates or (per)fluoroalkyl-functional organosiloxane condensates as per reaction steps c) and d).

As regards the reaction temperatures, it is suggested that reaction step a) be carried out at a temperature of from 40 to 120° C., preferably from 50 to 110° C., and reaction steps b) to e) be carried out at a temperature of from 20 to 120° C., preferably from 50 to 110° C.

The equivalence ratio of fluorine atoms to nitrogen atoms in the reaction products of steps c) and d) is preferably set to from 1:50 to 50:1, preferably from 1:25 to 25:1 and particularly preferably from 1:12.5 to 12.5:1. The equivalence ratio of alkoxysilane groups to water in step c) should be from 1:10 to 10:1 and preferably from 1:5 to 5:1.

The molar ratio of silicon atoms to water in step c) is preferably set to from 1:10 to 10:1, more preferably from 1:5 to 5:1 and particularly preferably 1:1.5.

The solids content of the fluorine-containing compositions comprising the components (A), (Y)(i) and (Z) in reaction steps a) and b) should be set to from 5 to 100% by weight, preferably 100% by weight. In reaction step c), the solids content of the fluorine-containing compositions comprising the components (A), (E), (U)(iv), (T), (V), (Y)(i) and (Z) should be set to from 25 to 100% by weight, preferably from 50 to 100% by weight. The solids content of the fluorine-containing compositions comprising the components (A), (E), (U)(iv), (T), (V), (Y)(i) and (Z) in reaction step d) is set to from 0.001 to 100% by weight, preferably from 0.5 to 50% by weight and particularly preferably from 1 to 15% by weight.

In reaction steps c) and d), the present invention provides for pH values of the fluorine-containing compositions which are set, independently of one another, to from 1 to 14, preferably from 2 to 6 and particularly preferably from 3 to 5.

In these reaction steps, the viscosity (Brookfield) of the fluorine-containing compositions should have been set to from 1 to 100 mPa·s.

In general, reaction steps c) and d) in the process of the invention are carried out by mixing the silane components (A), (E), (T) and (V), adding alcohol if appropriate, jointly hydrolysing and cocondensing the mixture and removing the alcohol including hydrolysis alcohol by distillation.

The alkoxysilanes which are used in the process of the invention are preferably methoxysilanes and/or ethoxysilanes. If an alcohol is added while carrying out the process of the invention, this is preferably methanol and/or ethanol.

Mixing of the silane components (A), (E), (T) and (V) can be carried out in a temperature range from the solidification point to the boiling point of the silane components used. In general, an excess of water is added to the silane mixture to carry out the hydrolysis, as a result of which hydroxy-functional organosiloxanes are generally obtained. However, the hydrolysis or cocondensation can also be carried out using a stoichiometic or substoichiometric amount of water. If the amount of water introduced in the reaction is restricted to less than 3 mol of water per mole of silane component used, it is possible, according to the invention, to produce (per)fluoroalkyl-functional organopolysiloxane condensates which contain essentially alkoxy groups. In the reaction, the (per)fluoroalkyl-functional organopolysiloxane condensates according to the invention are usually obtained as a mixture.

In the process of the invention, the alcohol or hydrolysis alcohol is usually removed by distillation, which should preferably be carried out at a temperature of <90° C., particularly preferably <60° C. and, to avoid damaging the product, under reduced pressure. Here, the content of the alcohol in the composition is appropriately reduced to less than 5% by weight, preferably less than 1% by weight and particularly preferably less than 0.5% by weight. The distillation can advantageously be carried out by means of a distillation column and be continued until no more alcohol can be detected at the top of the column; the desired product obtained at the bottom of the column can, if appropriate, be worked up further. If substances causing turbidity occur, these can be removed from the product by means of filtration, sedimentation, centrifugation or similar standard methods.

As catalyst, it is possible to use, in particular, a protic acid or a mixture of protic acids. Furthermore, said acids can also be used for adjusting the pH of the (per)fluoroalkyl-functional organopolysiloxane condensates according to the invention.

The (per)fluoroalkyl-functional organopolysiloxane condensates of the invention are generally based on [M], [D] and [T] structural units, with which a person skilled in the art will be familiar, with the oligomeric or polymeric organosiloxane structural units also being able to form aggregates. Such organosiloxanes usually bear not only the functional groups according to the invention but also, as further functions, alkoxy and/or hydroxyl groups whose proportion can generally be controlled via the amount of water added during the preparation and the completeness of alcohol removal.

Furthermore, it is recommended that the concentration of the (per)fluoroalkyl-functional organopolysiloxane condensates of the invention in aqueous solution be set to an active content of <50% by weight. An active content above 50% by weight can lead to gel formation or severe turbidity.

The (per)fluoroalkyl-functional organopolysiloxane condensates of the invention can be diluted with water without restriction in any ratio. In the case of completely hydrolysed systems, there is generally no formation of any additional hydrolysis alcohol. In general, low-viscosity, slightly opalescent liquids are obtained. However, it is also possible to dissolve the (per)fluoroalkyl-functional organopolysiloxane condensates of the invention in alcohol or incorporate them into water-soluble emulsions.

The (per)fluoroalkyl-functional organopolysiloxane condensates of the invention and diluted systems in which these are present generally display excellent storage stability for more than 6 months.

Finally, the present invention further provides for the use of the fluorine-containing compositions of the invention in the building sector or the industrial sector for the permanent oil-, water- and dirt-repellent surface treatment or modification of mineral and nonmineral substrates, e.g.
inorganic surfaces,
e.g. porous and nonporous, absorbent and nonabsorbent, rough and polished building materials and materials of construction of all types based on cement (concrete, mortar), lime, gypsum plaster, anhydrite, geopolymers, silica and silicates, synthetic stone, natural stone (e.g. granite, marble, sandstone, slate, serpentine), clay and also enamels, fillers and pigments, glass and glass fibres, ceramic, metals and metal alloys,
organic surfaces,
e.g. wovens and textiles, wood and wood materials, rubber, wood veneer, glass-reinforced plastics (GRP), plastics, leather and artificial leather, natural fibres, paper, polymers of all types,
composites of all types, if appropriate with nanosize constituents.

The fluorine-containing compositions of the invention are also particularly suitable for permanent oil-, water- and dirt-repellent surface treatment or modification, especially in the on-site and/or off-site sector of building and industry, e.g. for the applications
hydrophobicization and oleophobicization
antigraffiti
antisoiling
easy-to-clean
low dirt pick-up
nanostructured surfaces with Lotus-Effekt®
building protection
corrosion protection
seals
coatings
impregnation
surface sealing.

In addition, the fluorine-containing compositions of the invention can be used for the following application areas in the abovementioned building and industrial sector (on-site and/or off-site):
additives for paints and coating systems
automobile and motor vehicle industry
finished concrete parts
concrete mouldings
in-situ concrete
spray concrete
ready-mixed concrete
roofing tiles
electrical and electronics industry
paints and varnishes
tiles and grouting
wovens and textiles
glass facades and glass surfaces
wood machining and processing (veneers, impregnation)
ceramics and sanitaryware
adhesives and sealants
corrosion protection
acoustic insulation walls
plastic films
leather treatment
surface modification of fillers, pigments, nanoparticles
paper and board coating
plasters and renders, including decorative plasters and renders
thermal insulation composite systems (TICS) and thermal insulation systems (TIS)
fibrocement boards.

In this context, particular emphasis should be placed on the suitability of the fluorine-containing compositions of the invention for the full-body hydrophobicization/oleophobicization of concrete in the building or industrial sector (on-site and/or off-site), e.g.
on-site concrete
concrete products (finished concrete parts, concrete wares, concrete bricks/blocks)
in-situ concrete
spray concrete
ready-mixed concrete.

Furthermore, the fluorine-containing compositions of the invention are very well suited as monomers or macromonomers for sol-gel systems.

The (per)fluoroalkyl-functional organopolysiloxane condensates of the invention can thus be used with excellent results as compositions for the hydrophobicization and/or oleophobicization of surfaces, as building protection compositions, as compositions for the treatment of concrete, mineral natural materials and also glazed and unglazed ceramic products, as additive in preparations for surface treatment, for “antigraffiti” applications and in compositions for “antigraffiti” applications, for “easy-to-clean” applications and in compositions for “easy-to-clean” applications, as water-soluble bonding agents, as constituent of coating systems and in corrosion protection agents, for the biocidal treatment of surfaces, for the treatment of wood, for the treatment of leather, leather products and pelts, for the treatment of glass surfaces, for the treatment of plate glass, for the treatment of plastic surfaces, for the production of pharmaceutical and cosmetic products, for the modification of glass and mineral surfaces and also glass and mineral fibre surfaces, for the production of synthetic bricks, for the treatment of wastewater, for the surface modification and treatment of pigments and also as constituent of paints and varnishes.

The (per)fluoroalkyl-functional organopolysiloxane condensate according to the invention can be applied from 50% strength solution or from dilute solution, with, for example, water being able to be used as diluent. In principle, it is also possible to dilute the composition of the invention with an appropriate alcohol.

In addition, the (per)fluoroalkyl-functional organopolysiloxane condensates claimed result in a further-improved beading behaviour of a correspondingly treated, mineral surface, when using both hydrophilic and hydrophobic standard test liquids (tests in accordance with the “Teflon® Specification Test Kit” of DuPont de Nemours). At this point, reference will be made to the examples.

The compositions of the invention are advantageously used in an amount of from 0.00001 to 1 kg per m² of the surface to be coated and per operation.

In addition, it has been found to be advantageous for the inventive (per)fluoroalkyl-functional organosiloxane precondensates or (per)fluoroalkyl-functional organosiloxane condensates as per reaction step c) and d) to be applied using HVLP technology. In general, the application of the compositions claimed can be carried out using the methods known from surface coatings technology, e.g. flooding, pouring, HVLP processes, doctor blade coating, rolling, spraying, painting, dipping and roller application.

Owing to their oligomeric structure, the fluorine-containing compositions of the invention preferably have a high concentration of silanol functions which have an excellent ability to react with hydroxyl-containing substrate surfaces. Coatings and impregnations of various substrates display excellent oil- and at the same time water-repellent properties even after heat, surfactant and UV treatment. In corresponding studies, it was also able to be shown that, on various substrates, no reduction of the effectiveness or destabilization of the fluorine-containing compositions of the invention was discernible even after >6 months. Use of the fluorine-containing compositions of the invention makes it possible to achieve a simultaneous hydrophobicizing, oleophobicizing, dirt- and paint-repellent effect on various substrate surfaces in a simple and advantageous way.

Drying and curing of the coatings produced from the compositions of the invention is generally carried out at normal (exterior and interior) temperatures in the range from 0 to 50° C., i.e. without specific heating of the coatings. However, depending on the application, this can also be carried out at higher temperatures up to 150° C.

The following examples illustrate the invention.

### EXAMPLES

Chemicals used:

| | |
|---|---|
| Fluowet ® EA 612: | Fluoroalcohol mixture from Clariant GmbH |
| Fluowet ® EA 812 AC: | Fluoroalcohol mixture from Clariant GmbH |
| Daikin A-1820: | Fluoroalcohol from Daikin industries, Ltd. |
| Silquest ® A-1230 Silane: | Polyether-modified alkoxysilane from |
| | GE-Silicones |
| HFPO oligomer methyl ester: | Monofunctional methyl ester of |
| | polyhexafluoropropene oxide carboxylic acid- |
| | from Dyneon GmbH & Co. KG |
| DYNASILAN ® AMEO: | 3-Aminopropyltriethoxysilane from Degussa AG |
| DYNASILAN ® AMMO: | 3-Aminopropyltrimethoxysilane from Degussa AG |
| DYNASILAN ® TRIAMO: | N-[N′-(2-Aminoethyl)-2-aminoethyl]-3- |
| | aminopropyltrimethoxysilane from Degussa AG |
| MPEG 300, 500, 1000: | Monohydroxy-functional methylpolyethylene |
| | glycol having a molar mass of 300, 500, |
| | 1000 g/mol |
| DBTL: | Dibutyltin dilaurate |

### Example 1

### Fluorosilane (1)

A mixture of 200.00 g (561.96 mmol) of Fluowet® EA 612 and 143.31 g (561.98 mmol) of 3-(triethoxysilyl)propyl isocyanate was placed in a 500 ml three-neck round-bottom flask provided with internal thermometer, precision glass stirrer and Dimroth condenser. After addition of 0.34 g of DBTL as catalyst, the reaction mixture was heated to 70° C. and stirred at this temperature for about 2 hours until the reaction was complete. A viscous liquid containing some solids and having a residual NCO content of 0.18% by weight was obtained as product.

Isocyanate content: calculated: 0% by weight. found: 0.18% by weight

### Example 2

### Fluorosilane (2)

44.00 g (84.42 mmol) of Fluowet® EA 812 AC were placed in a 100 ml three-neck round-bottom flask provided with an internal thermometer, dropping funnel, air condenser and magnetic stirrer bar and, after addition of 0.07 g of DBTL as catalyst, heated to 70° C. At this temperature, 21.75 g (84.41 mmol) of 3-(triethoxysilyl)propyl isocyanate were added dropwise over a period of 1 hour. To complete the reaction, the mixture was stirred at room temperature for a further 2 hours. A viscous liquid containing some solids and having a residual NCO content of 0.08% by weight was obtained as product.

Isocyanate content: calculated: 0% by weight. found: 0.08% by weight

### Example 3

### Fluorosilane (3)

100 g of HFPO oligomer methyl ester (Mₙ=1008 g/mol, 0.099 mol) were placed in a 250 ml three-neck round-bottom flask equipped with a dropping funnel, precision glass stirrer and reflux condenser. 17.75 g of DYNASILAN® AMMO (M=179.29 g/mol, 0.099 mol) were slowly added while stirring and the mixture was stirred for another 30 minutes. To complete the reaction, the mixture was subsequently stirred at 60° C. for a further three hours and the hydrolysis alcohol formed was distilled off under reduced pressure. A colourless, slightly viscous liquid was obtained as product.

### Example 4

### Stabilization Component

The synthesis of the polyhydroxysilane (“sugar silane”) used as hydrophilic stabilization component was carried out by a method based on previously published preparative methods (e.g. DE 3600714 C2):

A solution of 62.14 g of DYNASILAN® AMEO (M=221.37 g/mol, 280.7 mmol) in 150 ml of absolute ethanol was added to a suspension of 100.01 g of δ-gluconolactone (M=178.14 g/mol, 280.7 mmol) in 250 ml of absolute ethanol while stirring and the mixture was stirred further for a short time. To complete the reaction, the clear solution was refluxed for a further 60 minutes. Distilling off the solvent on a rotary evaporator gave a clear, water-soluble solid as product.

### Example 5

### Hydrophilic Silane Component

Hydrophilic silane components used are first and foremost polyethylene glycol-modified alkoxysilanes. As commercial product, use was made of Silquest® A-1230 Silane.

### Examples 6-11

### Fluorosilanes

A mixture of Fluowet® EA 612, MPEG and 3-(triethoxysilyl)propyl isocyanate as per Table 2 was placed in a 500 ml three-neck round-bottom flask provided with an internal thermometer, precision glass stirrer and reflux condenser. After addition of about 0.1% by weight of DBTL as catalyst, the reaction mixture was heated to 70° C. and stirred for about 2-6 hours until complete reaction of all isocyanate groups had occurred. In all cases, viscous liquids/suspensions having residual NCO concentrations of less than 0.2% by weight were obtained as product mixture. To stabilize the product further, a polyhydroxysilane as per Example 16 was subsequently added to the mixture.

### Examples 18-23

### Fluorosilanes

| | Silquest ® A-Link | | | |
|---|---|---|---|---|
| Ex. | 25 Silane | Daikin A-1820 | MPEG | Polyhydroxylsilane (Ex. 4) |
| 6 | 15.14 g | 9.38 g | 12.25 g MPEG 300 | — |
| | (61.2 mmol) | (20.2 mmol) | (M = 300 g/mol, 41.0 mmol) | |
| 7 | 15.14 g | 9.38 g | 12.25 g MPEG 300 | 0.37 g |
| | (61.2 mmol) | (20.2 mmol) | (M = 300 g/mol, 41.0 mmol) | (M = 399.51 g/mol, 0.9 mmol) |
| 8 | 15.14 g | 14.20 g | 9.18 g MPEG 300 | 0.39 g |
| | (61.2 mmol) | (30.6 mmol) | (M = 300 g/mol, 30.6 mmol) | (M = 399.51 g/mol, 1.0 mmol) |
| 9 | 15.14 g | 19.03 g | 6.06 g MPEG 300 | 0.40 g |
| | (61.2 mmol) | (41.0 mmol) | (M = 300 g/mol, 20.2 mmol) | (M = 399.51 g/mol, 1.0 mmol) |
| 10 | 15.14 g | 19.03 g | 10.1 g MPEG 500 | 0.89 g |
| | (61.2 mmol) | (41.0 mmol) | (M = 500 g/mol, 20.2 mmol) | (M = 399.51 g/mol, 1.8 mmol) |
| 11 | 15.14 g | 19.03 g | 20.2 g MPEG 1000 | 2.72 g |
| | (61.2 mmol) | (41.0 mmol) | (M = 1000 g/mol, 20.2 mmol) | (M = 399.51 g/mol, 6.8 mmol) |

### Example 12

### (Per)Fluoroalkyl-Functional Organopolysiloxane Condensate

40.6 g (62.2 mmol of Si) of the silane mixture obtained in Example 20 and 12.17 g (54.98 mmol) of DYNASILAN® AMEO were placed in a 250 ml three-necked round-bottom flask provided with internal thermometer, dropping funnel and magnetic stirrer bar. After addition of 3.13 g (174.3 mmol) of water from the dropping funnel, the reaction mixture was stirred at 60° C. for 3 hours and subsequently cooled to room temperature. To neutralize the amine, 4.64 g (85.68 mmol) of an 85% strength aqueous formic acid were then added and the mixture was stirred for a short time. A viscous, clear liquid was obtained as product.

To oligomerize the precondensate obtained, 15.00 g of the product obtained were mixed with 85.00 g of water and the hydrolysis alcohol formed was removed completely by vacuum distillation. The amount of hydrolysis alcohol distilled off was then replaced by water. An aqueous solution having a solids content of 15% by weight was obtained as product.

### Example 13

### (Per)Fluoroalkyl-Functional Organopolysiloxane Condensate

A mixture of 13.05 g (21.34 mmol) of fluorosilane (1), 12.17 g (54.98 mmol) of DYNASILAN® AMEO, 12.25 g of Silquest® A-1230 Silane (23.38 mmol) and 0.37 g (0.9 mmol) of polyhydroxysilane (from Example 16) was placed in a 250 ml three-neck round bottom flask provided with internal thermometer, precision glass stirrer and reflux condenser. After addition of 2.72 g (150.9 mmol) of water, the reaction mixture was stirred at 60° C. for 3 hours. To neutralize the amine, the mixture was cooled to room temperature, admixed with 4.64 g (85.68 mmol) of an 85% strength aqueous formic acid and stirred further for a short time. A viscous, slightly yellowish liquid/suspension was obtained as product.

To carry out the oligomerization, the product obtained was admixed with 197.89 g of water and the hydrolysis alcohol formed was removed by vacuum distillation. An opalescent aqueous solution was obtained as product.

### Overview of Components

(A)(i) fluorosilane component
(A)(ii) preformed fluorosilane component
(B)(i) (per)fluoroalkyl alcohol component
(B)(ii) (per)fluoroalkylalkylenamine component
(B)(iii) fluorine-modified macromonomers or telechelic polymers
(B)(iv) (per)fluoroalkylalkylene isocyanate component
(B)(v) (per)fluoroalkylcarboxylic acid derivative component
(C)(i) isocyanatoalkylalkoxysilane component
(C)(ii) other isocyanatosilane component
(D)(i) polyisocyanate component
(D)(ii) polyisocyanate component
(E)(i) aminoalkylalkoxysilane component
(E)(ii) other aminosilane component
(E)(iii) nonionic slime component
(E)(iv) aminosilicone oil component
(E)(v) low molecular weight silane component
(E)(vi) hydrophilicized aqueous silane component
(F)(i) monofunctional hexafluoropropene oxide component
(F)(ii) bifunctional hexafluoropropene oxide component
(G)(i) monofunctional polyalkylene glycol component
(G)(ii) monofunctional polyoxyalkylenamine component
(G)(iii) polyfunctional polyalkylene glycol component
(G)(iv) polyfunctional polyoxyalkylenamine component
(H) triazine component
(I) hydroxycarboxylic acid component
(J) NCN component
(K) carbonyl component
(L)(i) mercaptoalkylalkoxysilane component
(L)(ii) other mercaptosilane component
(M) (per)fluoroalkylalkylene oxide component
(N)(i) epoxyalkylolalkoxysilane component
(N)(ii) other epoxysilane component
(O) polyamine component
(P)(i) epoxy-functional polyhedral oligomeric polysilasesquioxane component
(P)(ii) amino-functional polyhedral oligomeric polysilasesquioxane component
(P)(iii) (meth)acryloyl-functional polyhedral oligomeric polysilasesquioxane component
(Q)(i) amino alcohol component
(Q)(ii) other amino alcohol component
(R) catalyst component
(S)(i) solvent component
(S)(ii) solvent component
(T) stabilizing component
(U)(i) acid component
(U)(ii) acid component
(U)(iii) acid component
(U)(iv) acid component
(V) hydrophilic silane component
(W) neutralization component
(Y)(i) formulation component
(Y)(ii) (reactive) nanoparticle component
(Z) functionalization component

1. A liquid, fluorine-containing and single-component compositions having a fluorine content based on the solid resin of from 5 to 75% by weight for the permanent surface treatment of porous and nonporous substrates, obtainable by first
a) preparing a fluorosilane component (A)(i) having a polymer-bonded fluorine content of from 5 to 95% by weight and a polymer-bonded silicon content of from 95 to 5% by weight by
a₁) reacting from 5 to 95% by weight of a (per)fluoroalkyl alcohol component (B)(i) and/or a (per)fluoroalkylalkylenamine component (B)(ii) comprising perfluoroalkyl alcohols having terminal methylene groups (hydrocarbon spacers) of the general formula
CF₃—(CF₂)ₓ—(CH₂)_{y}—O-A_{z}-H
or
CR₃—(CR₂)ₓ—(CH₂)_{y}—O-A_{z}-H
where x=3-20, y=1-6, z=0-100, R═, independently of one another, H, F, CF₃, A=CRⁱRⁱⁱ—CRⁱⁱⁱR^{iv}—O or (CRⁱRⁱⁱ)ₐ—O or CO—(CRⁱRⁱⁱ)_{b}—O where Rⁱ, Rⁱⁱ, Rⁱⁱⁱ, R^{iv}═, independently of one another, H, alkyl, cycloalkyl, aryl or any organic radical having in each case 1-25 carbon atoms, a, b=3-5, where the polyalkylene oxide structural unit A_{z} is a homopolymer, copolymer or block copolymer of any alkylene oxides or a polyoxyalkylene glycol or a polylactone,
and/or
a hexafluoropropene oxide (HFPO) oligomer alcohol of the general formula
CF₃—CF₂—CF₂-[O—CF(CF₃)—CF₂]ₓ—O—CF(CF₃)—(CH₂)_{y}—O-A_{z}-H
and/or
a fluorine-modified macromonomer or telechelic polymer (B)(iii), for example a hydroxy-functional reaction product of the components (F)(i) and (F)(ii) with the components (Q)(i) and (Q)(ii), having a polymer-bonded fluorine content of from 1 to 99% by weight, a molecular mass of from 100 to 10 000 dalton and in each case one or more reactive (cyclo)aliphatic and/or aromatic hydroxyl group(s) and/or primary and/or secondary amino group(s) and/or mercapto group(s) and containing the structural elements
—(CF₂—CF₂)ₓ
and/or
—(CR₂—CR₂)ₓ—
and/or
—[CF₂—CF(CF₃)—O]ₓ—
and/or
—(CR₂—CR₂—O)ₓ—
arranged intrachenally and/or laterally and/or terminally in the main chain and/or side chain
with from 95 to 5% by weight of an isocyanatoalkylalkoxysilane component (C)(i) comprising a 3-isocyanatopropyltrialkoxysilane and/or a 3-isocyanatopropylalkoxyalkylsilane and/or isocyanatoalkylalkoxysilanes of the general formula
OCN—(CR²₂)_{y′}—Si(OR¹)_{3-x′}R²_{x′}
where x′=0-2, y′=1-3 and R¹, R²═, independently of one another, alkyl, cycloalkyl, aryl, any organic radical in each case having 1-25 carbon atoms,
and/or another isocyanatosilane component (C)(ii) having a molecular mass of from 200 to 2000 dalton and in each case one or more (cyclo)aliphatic and/or aromatic isocyanato group(s) and one or more alkoxysilane group(s), with the reaction preferably being carried out in a molar ratio of 1:1 in any way,
and/or
a_{2.1}) reacting from 5 to 95% by weight of a (per)fluoroalkyl alcohol component (B)(i) and/or a (per)fluoroalkylalkylenamine component (B)(ii) and/or fluorine-modified macromonomers or telechelic polymers (B)(iii) with from 75 to 5% by weight of a polyisocyanate component (D)(i) comprising at least one diisocyanate, polyisocyanate, polyisocyanate derivative or polyisocyanate homologue having two or more (cyclo)aliphatic and/or aromatic isocyanate groups of identical or different reactivity, with the reaction conditions and the selectivities of the components (B) and (D) being selected so that only one isocyanate group of the component (D)(i) reacts with the component (B),
a_{2.2}) subsequently reacting the preadduct from step a_{2.1}) with from 75 to 5% by weight of an aminoalkylalkoxysilane component (E)(i) comprising a 3-aminopropyltrialkoxysilane and/or a (substituted) 3-aminopropylalkoxyalkylsilane of the general formula
R³₂N—(CR³₂)_{y′}—Si(OR¹)_{3-x′}R²_{x′}
where x′=0-2, y′=1-6 and R¹, R²═, independently of one another, alkyl, cycloalkyl, aryl, any organic radical having in each case 1-25 carbon atoms, R³═, independently of one another, alkyl, cycloalkyl, aryl, any organic radical having 1-25 carbon atoms, (R¹⁰)_{3-x′}R²_{x′}Si(CR³₂)_{y′}, R^{3′}₂N—(CR^{3′}₂)_{y′}—[NH—(CR^{3′}₂)_{y′}]_{n′} where n′=0-10, where R^{3′}=, independently of one another, alkyl, cycloalkyl, aryl, any organic radical having in each case 1-25 carbon atoms,
and/or an aminosilane component (E)(ii) different from (E)(i) having a molecular mass of from 200 to 2000 dalton and in each case one or more primary and/or secondary and/or tertiary amino group(s) and one or more alkoxysilane group(s), with the reaction preferably being carried out in a molar ratio of 1:1:1 in any way,
and/or
a₃) reacting from 5 to 95% by weight of a (per)fluoroalkylalkylene isocyanate component (B)(iv) of the general formula
CF₃—(CF₂)ₓ—(CH₂)_{y}—NCO
or
CR₃—(CR₂)ₓ—(CH₂)_{y}—NCO
having a molecular mass of from 200 to 2000 dalton and one or more (cyclo)aliphatic and/or aromatic isocyanato group(s) with from 95 to 5% by weight of an aminosilane component (E)(i) and/or (E)(ii), giving an adduct of the general formula
(B)(iv)-(E)
where (B)(iv)=protonated component (B)(iv) and (E)=deprotonated components (E)(i) and/or (E)(ii),
with the reaction preferably being carried out in a molar ratio of 1:1 in any way,
and/or
a₄) reaction products having two or more hydroxyl groups from 5 to 95% by weight of a (per)fluoroalkylalkane carboxylic acid (derivative) component (B)(v) of the general formula
CF₃—(CF₂)ₓ—(CH₂)_{y}—COR⁴
or
CR₃—(CR₂)ₓ—(CH₂)_{y}—COR⁴
where R⁴═F, Cl, Br, I, OH, OMe, OEt,
having a molecular mass of from 200 to 200 dalton and one or more carboxylic acid (derivative) group(s) with from 95 to 5% by weight of an aminosilane component (E)(i) and/or (E)(ii), resulting in elimination of HR⁴ to give an adduct of the general formula
(B)(v)-(E)
where (B)(v)=carbonyl radical of the component (B)(v) and (E)=deprotonated components (E)(i) and/or (E)(ii),
with the reaction preferably being carried out in a molar ratio of 1:1 in any way,
and/or
a₅) reacting from 5 to 95% by weight of a hexafluoropropene oxide component (F)(i) comprising monofunctional hexafluoropropene oxide oligomers of the general formula
CF₃—CF₂—CF₂—O—(CF(CF₃)—CF₂—O)ₙ—CF(CF₃)—COR⁴
where m=1-20
with from 95 to 5% by weight of an aminosilane component (E)(i) and/or (E)(ii), resulting in elimination of HR⁴ to form adducts of the general formula
(F)(i)-(E)
where (F)(i)=carbonyl radical of the component (F)(i) and (E)=deprotonated components (E)(i) and/or (E)(ii),
with the reaction preferably being carried out in a molar ratio of 1:1 in any way,
and/or
a₆) reacting from 5 to 95% by weight of a hexafluoropropene oxide component (F)(ii) comprising bifunctional hexafluoropropene oxide oligomers of the general formula
R⁴OC—CF(CF₃)—(O—CF₂—CF(CF₃))ₙ—O—(CF₂)ₒ—O—(CF(CF₃)—CF₂—O)ₙ—CF(CF₃)—COR⁴
where n=1-10, o=2-6
with from 95 to 5% by weight of an aminoalkylalkoxysilane component (E)(i) and/or (E)(ii), resulting in elimination of HR⁴ to give adducts of the general formula
(E)-(F)(ii)-(E)
where (F)(ii)=carbonyl radical of the component (F)(i) and (E)=deprotonated components (E)(i) and/or (E)(ii),
with the reaction preferably being carried out in a molar ratio of 1:1 in any way,
and/or
a₇) reacting from 5 to 95% by weight of a (per)fluoroalkyl alcohol component (B)(i) and/or a (per)fluoroalkylalkylenamine component (B)(ii) and/or a fluorine-modified macromonomer or telechelic polymer (B)(iii) with from 75 to 5% by weight of an aminoalkylalkoxysilane component (E)(i) and/or (E)(ii) and from 75 to 5% by weight of a polyisocyanate component (D)(ii) comprising a triisocyanate, polyisocyanate, polyisocyanate derivative or polyisocyanate homologue having at least three (cyclo)aliphatic and/or aromatic isocyanate groups of identical or different reactivity, with the reaction in the case of trifunctional isocyanates preferably being carried out in a molar ratio of 2:1:1 or 1:2:1 in any way,
and/or
a₈) reacting from 5 to 75% by weight of a (per)fluoroalkyl alcohol component (B)(i) and/or a (per)fluoroalkylalkylenamine component (B)(ii) and/or a fluorine-modified macromonomer or telechelic polymer (B)(iii) with from 50 to 5% by weight of an aminoalkylalkoxysilane component (E)(i) and/or (E)(ii), from 50 to 5% by weight of a monofunctional polyalkylene glycol component (G)(i) and/or a monofunctional polyoxyalkylenamine component (G)(ii) comprising monohydroxyfunctional alkyl/cycloalkyl/arylpolyethylene glycols and/or alkyl/cycloalkyl/arylpoly(ethylene oxide-block-alkylene oxide) and/or alkyl/cycloalkyl/arylpoly(ethylene oxide-co-alkylene oxide) and/or alkyl/cycloalkyl/arylpoly(ethylene oxide-ran-alkylene oxide) comprising from 25 to 99.9% by weight of ethylene oxide and from 0 to 75% by weight of a further alkylene oxide having from 3 to 20 carbon atoms comprising propylene oxide, butylene oxide, dodecyl oxide, isoamyl oxide, oxetane, substituted oxetanes, α-pinene oxide, styrene oxide, tetrahydrofuran or further aliphatic or aromatic alkylene oxides having from 4 to 20 carbon atoms per alkylene oxide or mixtures thereof, of the general formula
R⁵—O-A_{z′}—H
where z′=5-150, R⁵=alkyl, cycloalkyl, aryl, any organic radical having 1-25 carbon atoms,
and/or
monoamino-functional alkyl/cycloalkyl/arylpolyethylene glycols and/or alkyl/cycloalkyl/arylpoly(ethylene oxide-block-alkylene oxide) and/or alkyl/cycloalkyl/arylpoly(ethylene oxide-co-alkylene oxide) and/or alkyl/cycloalkyl/arylpoly(ethylene oxide-ran-alkylene oxide) comprising from 25 to 99.9% by weight of ethylene oxide and from 0 to 75% by weight of a further alkylene oxide having from 3 to 20 carbon atoms comprising propylene oxide, butylene oxide, dodecyl oxide, isoamyl oxide, oxetane, substituted oxetanes, α-pinene oxide, styrene oxide, tetrahydrofuran or further aliphatic or aromatic alkylene oxides having from 4 to 20 carbon atoms per alkylene oxide or mixtures thereof, of the general formula
R⁵—O—(CRⁱRⁱⁱ—CRⁱⁱⁱR^{iv}—O)_{z′-1}—CRⁱRⁱⁱ—CRⁱⁱⁱR^{iv}—NH₂
and from 50 to 5% by weight of a polyisocyanate component (D)(ii), with the reaction in the case of trifunctional isocyanates preferably being carried out in a molar ratio of 1:1:1:1 in any way,
and/or
a₉) reacting from 5 to 95% by weight of a (per)fluoroalkyl alcohol component (B)(i) and/or a (per)fluoroalkylalkylenamine component (B)(ii) and/or a fluorine-modified macromonomer or telechelic polymer (B)(iii) with from 75 to 5% by weight of an aminoalkylalkoxysilane component (E)(i) and/or (E)(ii) and from 75 to 5% by weight of a triazine component (H) comprising cyanuric chloride or 2,4,6-trichloro-1,3,5-triazine, with the reaction preferably being carried out in a molar ratio of 2:1:1 or 1:2:1 in any way,
and/or
a₁₀) reacting from 5 to 75% by weight of a (per)fluoroalkyl alcohol component (B)(i) and/or a (per)fluoroalkylalkylenamine component (B)(ii) and/or a fluorine-modified macromonomer or telechelic polymer (B)(iii) with from 50 to 5% by weight of an aminoalkylalkoxysilane component (E)(i) and/or (E)(ii), from 50 to 5% by weight of a monofunctional polyalkylene glycol component (G)(i) and/or a monofunctional polyoxyalkylenamine component (G)(ii) and from 50 to 5% by weight of a triazine component (H) comprising cyanuric chloride or 2,4,6-trichloro-1,3,5-triazine, with the reaction preferably being carried out in a molar ratio of 1:1:1:1 in any way,
and/or
a₁₁) reacting from 5 to 75% by weight of a (per)fluoroalkyl alcohol component (B)(i) and/or a (per) fluoroalkylalkylenamine component (B)(ii) and/or a fluorine-modified macromonomer or telechelic polymer (B)(iii) with from 50 to 5% by weight of an aminoalkylalkoxysilane component (E)(i) and/or (E)(ii), from 50 to 5% by weight of a polyfunctional polyalkylene glycol component (G)(iii) and/or a polyfunctional polyoxyalkylenamine component (G)(iv) comprising polyhydroxy-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) comprising from 25 to 99.9% by weight of ethylene oxide and from 0 to 75% by weight of a further alkylene oxide having from 3 to 20 carbon atoms comprising propylene oxide, butylene oxide, dodecyl oxide, isoamyl oxide, oxetane, substituted oxetanes, α-pinene oxide, styrene oxide, tetrahydrofuran or further aliphatic or aromatic alkylene oxides having from 4 to 20 carbon atoms per alkylene oxide or mixtures thereof, of the general formula
R⁶(—O-A_{z′}—H)_{z″}
where z″=2-6, R⁶=alkyl, cycloalkyl, aryl, any organic radical having 1-25 carbon atoms,
and/or
polyamino-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) comprising from 25 to 99.9% by weight of ethylene oxide and from 0 to 75% by weight of a further alkylene oxide having from 3 to 20 carbon atoms comprising propylene oxide, butylene oxide, dodecyl oxide, isoamyl oxide, oxetane, substituted oxetanes, α-pinene oxide, styrene oxide, tetrahydrofuran or further aliphatic or aromatic alkylene oxides having from 4 to 20 carbon atoms per alkylene oxide or mixtures thereof, of the general formula
R⁶(—O-A_{z′-1}—CRⁱRⁱⁱ—CRⁱⁱⁱR^{iv}—NH₂)_{z″}
and from 50 to 5% by weight of a polyisocyanate component (D)(i), with the reaction in the case of dihydroxy-functional glycols preferably being carried out in a molar ratio of 1:1:1:2 in any way,
and/or
a₁₂) reacting from 5 to 75% by weight of a (per)fluoroalkyl alcohol component (B)(i) and/or a (per)fluoroalkylalkylenamine component (B)(ii) and/or a fluorine-modified macromonomer or telechelic polymer (B)(iii) with from 50 to 5% by weight of an aminoalkylalkoxysilane component (E)(i) and/or (E)(ii), from 50 to 5% by weight of a hydroxycarboxylic acid component (I) comprising a monohydroxycarboxylic acid and/or a dihydroxycarboxylic acid having one and/or two hydroxyl group(s) which is/are reactive towards isocyanates and a carboxyl group which is inert towards polyisocyanates and from 50 to 5% by weight of a polyisocyanate component (D)(ii) comprising at least one triisocyanate, polyisocyanate, polyisocyanate derivative or polyisocyanate homologue having at least three (cyclo)aliphatic and/or aromatic isocyanate groups of identical or different reactivity, with the reaction in the case of trifunctional isocyanates preferably being carried out in a molar ratio of 1:1:1:1 in any way,
and/or
a₁₃) reacting from 5 to 75% by weight of a (per)fluoroalkyl alcohol component (B)(i) and/or a (per)fluoroalkylalkylenamine component (B)(ii) and/or a fluorine-modified macromonomer or telechelic polymer (B)(iii) with from 50 to 5% by weight of an aminoalkylalkoxysilane component (E)(i) and/or (E)(ii), from 50 to 5% by weight of an NCN component (J) comprising cyanamide having an NH-acid amino group which is reactive towards polyisocyanates and from 50 to 5% by weight of a polyisocyanate component (D)(ii) comprising at least one triisocyanate, polyisocyanate, polyisocyanate derivative or polyisocyanate homologue having at least three (cyclo)aliphatic and/or aromatic isocyanate groups of identical or different reactivity, with the reaction in the case of trifunctional isocyanates preferably being carried out at a molar ratio of 1:1:1:1 in any way,
and/or
a₁₄) reacting from 5 to 95% by weight of a (per)fluoroalkyl alcohol component (B)(i) and/or a (per)fluoroalkylalkylenamine component (B)(ii) and/or a fluorine-modified macromonomer or telechelic polymer component (B)(iii), from 75 to 5% by weight of a carbonyl component (K) of the general formula
X—CO—Y
where X, Y═, independently of one another, F, Cl, Br, I, CCl₃, R⁷, OR⁷ where R⁷=alkyl, cycloalkyl, aryl, any organic radical having 1-25 carbon atoms, 0-10 N atoms and 0-10 O atoms,
with from 75 to 5% by weight of an aminoalkylalkoxysilane component (E)(i) and/or (E)(ii), resulting in, in the first stage, elimination of HX and/or HY to give an adduct of the general formula
(B)—CO—Y and/or X—CO—(B)
or
(E)-CO—Y and/or X—CO-(E)
where (B)=deprotonated components (B)(i) and/or (B)(ii) and/or (B)(iii), (E) ═deprotonated components (E)(i) and/or (E)(ii)
and, in the second stage, elimination of HX and/or HY to give an adduct of the general formula
(B)—CO-(E),
with the reaction preferably being carried out in a molar ratio of 1:1:1 in any way,
or
reacting from 5 to 95% by weight of a preformed adduct of the general formula
(B)—CO—Y and/or X—CO—(B)
with from 95 to 5% by weight of an aminoalkylalkoxysilane component (E)(i) and/or (E)(ii), resulting in elimination of HX and/or HY to give an adduct of the general formula
(B)—CO-(E),
with the reaction being preferably carried out in a molar ratio of 1:1 in any way,
or
reacting from 5 to 95% by weight of a preformed adduct of the general formula
(E)-CO—Y and/or X—CO-(E)
with from 95 to 5% by weight of a (per)fluoroalkyl alcohol component (B)(i) and/or a (per)fluoroalkylalkylenamine component (B)(ii) and/or a fluorine-modified macromonomer or telechelic polymer component (B)(iii), resulting in elimination of HX and/or HY to give an adduct of the general formula
(B)—CO-(E),
with the reaction preferably being carried out in a molar ratio of 1:1 in any way,
and/or
a₁₅) replacing the aminoalkylalkoxysilane component (E)(i) and/or the aminosilane component (E)(ii) in the case of the reaction products a₂) to a₁₄) by a mercaptoalkylalkoxysilane component (L)(i) comprising a 3-mercaptopropyltrialkoxysilane of the general formula
HS—(CR³₂)_{y′}—Si(OR¹)_{3-x′}R²_{x′}
and/or by another mercaptosilane component (L)(ii) having a molecular mass of from 200 to 2000 dalton and having one or more mercapto group(s) and one or more alkoxysilane group(s)
and/or
a₁₆) reacting from 5 to 95% by weight of a (per)fluoroalkylalkylene oxide component (M) of the general formula
CF₃—(CF₂)ₓ—(CH₂)_{y}—CHOCH₂
or
CR₃—(CR₂)ₓ—(CH₂)_{y}—CHOCH₂
or
CR₃—(CR₂)ₓ—(CH₂)_{y}—O—CH₂—CHOCH₂
having a molecular mass of from 200 to 2000 dalton and one or more epoxy group(s) with from 95 to 5% by weight of an aminosilane component (E)(i) and/or (E)(ii), with the reaction preferably being carried out in a molar ratio of 1:1 or 1:2 in any way,
and/or
a₁₇) reacting from 5 to 95% by weight of a (per)fluoroalkylalkylene oxide component (M), from 75 to 5% by weight of an epoxyalkylolalkoxysilane component (N)(i) and/or a component (N)(ii) different from (N)(i) comprising a (substituted) 3-glycidyloxypropyltrialkoxysilane of the general formula
CH₂OCH—CH₂—O—(CR³₂)_{y′}—Si(OR¹)_{3-x′}R²_{x′}
having a molecular mass of from 200 to 2000 dalton and one or more epoxy group(s) with from 75 to 5% by weight of a polyamine component (O) having a molecular mass of from 60 to 5000 dalton and one or more (cyclo)aliphatic and/or aromatic primary and/or secondary amino group(s) which is/are reactive towards epoxide groups and, if appropriate, one or more hydroxyl group(s), with the reaction preferably being carried out in a molar ratio of 1:1:1 or 2:2:1 in any way,
and/or
a₁₈) reacting from 5 to 95% by weight of an epoxy-functional polyhedral oligomeric polysilasesquioxane component (POSS) (P)(i) having one or more epoxy groups and one or more perfluoroalkyl groups of the general formula
(R⁸ᵤR⁹ᵥR¹⁰_{w}SiO_{1.5})ₚ
where 0<u<1, 0<v<1, 0<w<1, u+v+w=1,
p=4, 6, 8, 10, 12 and R⁸, R⁹, R¹⁰=, independently of one another, any inorganic and/or organic and if appropriate polymeric radical having from 1 to 250 carbon atoms and from 0 to 50 N atoms and/or from 1 to 50 O atoms and/or from 3 to 100 F atoms and/or from 0 to 50 Si atoms and/or from 0 to 50 S atoms,
with from 95 to 5% by weight of an aminosilane component (E)(i) and/or (E)(ii), with the reaction preferably being carried out in a molar ratio of 1:(>) 1 in any way,
and/or
a₁₉) reacting from 5 to 95% by weight of an amino-functional polyhedral oligomeric polysilasesquioxane component (POSS) (P)(ii) having one or more amino groups and one or more perfluoroalkyl groups of the general formula
(R⁸ᵤR⁹ᵥR¹⁰_{w}SiO_{1.5})_{P}
with from 95 to 5% by weight of an isocyanatoalkylalkoxysilane component (C)(i) and/or a component (C)(ii) different from (C)(i), with the reaction preferably being carried out in a molar ratio of 1:(>) 1 in any way,
and/or
a₂₀) reacting from 5 to 95% by weight of a (meth)acryloyl-functional polyhedral oligomeric polysilasesquioxane component (POSS) (P)(iii) having one or more (meth)acryloyl groups and one or more perfluoroalkyl groups of the general formula
(R⁸ᵤR⁹ᵥR¹⁰_{w}SiO_{1.5})ₚ
with from 95 to 5% by weight of an amino alcohol component (Q)(i) having one or more (cyclo)aliphatic and/or aromatic primary and/or secondary amino group(s) which is/are reactive towards epoxide groups and one or more hydroxyl group(s) having a molecular mass of from 60 to 5000 dalton and/or another amino alcohol component (Q)(ii), with the reaction preferably being carried out in a molar ratio of 1:(>) 1 in any way,
or using preformed fluorosilanes (A)(ii) such as
a₂₁) (per)fluoroalkylalkoxysilanes of the general formula
CF₃—(CF₂)ₓ—(CH₂)_{y}—Si(OR¹)_{3-x′}R²_{x′}
or
CR₃—(CR₂)ₓ—(CH₂)_{y}—Si(OR¹)_{3-x′}R²_{x′}
and/or
a₂₂) other reaction products containing the structural elements
—(CF₂—CF₂)ₓ—
and/or
—(CR₂—CR₂)ₓ—
and/or
—[CF₂—CF(CF₃)—O]ₓ—
and/or
—(CR₂—CR₂—O)ₓ—
and
—Si(OR¹)_{3-x′}R²_{x′},
where from 2.5 to 250 parts by weight of the pure fluorosilane component (A) and also from 0 to 10 parts by weight of a catalyst component (R) and from 0 to 250 parts by weight of a solvent component (S)(i) are present,
b₁) if appropriate partly or completely removing the solvent component (S)(i) from step a) by distillation before, during or after the reaction,
b₂) if appropriate partly or completely removing the catalyst component (R) from step a) by means of suitable absorption materials or other measures after the reaction,
b₃) dissolving the mixture from step a) in from 0 to 250 parts by weight of a solvent component (S)(ii) before, during or after the reaction,
c₁) (partially) hydrolyzing or silanolizing the mixture from steps a) or b) with from 0 to 100 parts by weight of an aminosilane component (E)(i) and/or (E)(ii) and from 0.1 to 100 parts by weight of a stabilizing component (T) comprising
c_{1.1}) reaction products of from 5 to 95% by weight of an amino alcohol component (Q)(i) and/or another amino alcohol component (Q)(ii) and from 95 to 5% by weight of an isocyanatosilane component (C)(i) and/or (C)(ii), with the reaction preferably being carried out in a molar ratio of 1:1 in any way,
and/or
c_{1.2}) reaction products of from 5 to 75% by weight of an amino alcohol component (Q)(i) and/or another amino alcohol component (Q)(ii), from 75 to 5% by weight of an aminosilane component (E)(i) and/or (E)(ii) and from 75 to 5% by weight of a polyisocyanate component (D)(i), with the reaction preferably being carried out in a molar ratio of 1:1:1 in any way,
and/or
c_{1.3}) reaction products of from 5 to 95% by weight of a hydroxycarboxylic acid component (I) and from 95 to 5% by weight of an isocyanatosilane component (C)(i) and/or (C)(ii), with the reaction preferably being carried out in a molar ratio of 1:1 in any way,
and/or
c_{1.4}) reaction products of from 5 to 75% by weight of a hydroxycarboxylic acid component (I), from 75 to 5% by weight of an aminosilane component (E)(i) and/or (E)(ii) and from 75 to 5% by weight of a polyisocyanate component (D)(i), with the reaction preferably being carried out in a molar ratio of 1:1:1 in any way,
and/or
c_{1.5}) reaction products of from 5 to 95% by weight of an NCN component (J) and from 95 to 5% by weight of an isocyanatosilane component (C)(i) and/or (C)(ii), with the reaction preferably being carried out in a molar ratio of 1:1 in any way,
and/or
c_{1.6}) reaction products of from 5 to 75% by weight of an NCN component (J), from 75 to 5% by weight of an aminosilane component (E)(i) and/or (E)(ii) and from 75 to 5% by weight of a polyisocyanate component (D)(i), with the reaction preferably being carried out in a molar ratio of 1:1:1 in any way,
and/or
c_{1.7}) reaction products of from 5 to 95% by weight of an aminosilane component (E)(i) and/or (E)(ii) and from 95 to 5% by weight of an acid component (U)(i) comprising unsaturated carboxylic acids, with the reaction preferably being carried out in a molar ratio of 1:>1 in any way,
and/or
c_{1.8}) reaction products of from 5 to 95% by weight of an aminosilane component (E)(i) and/or (E)(ii) and from 95 to 5% by weight of an acid component (U)(ii) comprising unsaturated carboxylic anhydrides, with the reaction preferably being carried out in a molar ratio of 1:>1 in any way,
and/or
c_{1.9}) reaction products of from 5 to 95% by weight of an aminosilane component (E)(i) and/or (E)(ii) and from 95 to 5% by weight of an acid component (U)(iii) comprising γ- and/or δ-lactones of onic acids or sugar acids or polyhydroxy(di)carboxylic acids or polyhydroxycarboxylic aldehydes, with the reaction in the case of monolactones preferably being carried out in a molar ratio of 1:1 and in the case of dilactones preferably being carried out in a molar ratio of 2:1 in any way to give hydrophilic silanes of the general formula
(E)-CO—[CH(OH)₄]—CH₂OH
and/or
(E)-CO—[CH(OH)₄]—CHO
and/or
(E)-CO—[CH(OH)₄]—CO-(E),
where the reaction products c_{1.1}) to c_{1.9}) contain from 0 to 10 parts by weight of a catalyst component (R), from 0 to 250 parts by weight of a solvent component (S)(i) and from 0 to 250 parts by weight of a solvent component (S)(ii),
and from 0.1 to 100 parts by weight of a hydrophilic silane component (V) comprising
c_{1.10}) a nonionic silane component (E)(iii) of the general formula
R¹¹—O-A_{z}-(CH₂)_{y′}—Si(OR¹)_{3-x′}R²_{x′}
and/or
HO-A_{z′}—(CH₂)_{y′}—Si(OR¹)_{3-x′}R²_{x′}
where R¹¹=alkyl, cycloalkyl, aryl, any organic radical having in each case 1-25 carbon atoms,
and/or
c_{1.11}) reaction products of from 5 to 95% by weight of a monofunctional polyalkylene glycol component (G)(i) and/or a monofunctional polyoxyalkylenamine component (G)(ii) and/or a polyfunctional polyalkylene glycol component (G)(iii) and/or a polyfunctional polyoxyalkylenamine component (G)(iv) and from 95 to 5% by weight of an isocyanatosilane component (C)(i) and/or (C)(ii), with the reaction in the case of monohydroxy- or monoamino-functional glycols preferably being carried out in a molar ratio of 1:1 in any way,
and/or
c_{1.12}) reaction products of from 5 to 75% by weight of a monofunctional polyalkylene glycol component (G)(i) and/or a monofunctional polyoxyalkylenamine component (G)(ii) and/or a polyfunctional polyalkylene glycol component (G)(iii) and/or a polyfunctional polyoxyalkylenamine component (G)(iv), from 75 to 5% by weight of an aminosilane component (E)(i) and/or (E)(ii) and from 75 to 5% by weight of a polyisocyanate component (D)(i), with the reaction in the case of monohydroxy- or monoamino-functional glycols preferably being carried out in a molar ratio of 1:1:1 in any way,
and/or
c_{1.13}) reaction products of from 5 to 95% by weight of a polyoxyalkylenamine component (G)(ii) and/or a polyfunctional polyoxyalkylenamine component (G)(iv) and from 95 to 5% by weight of an epoxyalkylolalkoxysilane component (N)(i) and/or an epoxysilane component (N)(ii) different from (N)(i), with the reaction in the case of monoamino-functional glycols preferably being carried out in a molar ratio of 1:1 or 1:2 in any way,
and/or
c_{1.14}) reaction products of from 5 to 75% by weight of a monofunctional polyalkylene glycol component (G)(i) and/or a monofunctional polyoxyalkylenamine component (G)(ii), from 50 to 5% by weight of an aminosilane component (E)(i) and/or (E)(ii) and from 50 to 5% by weight of a polyisocyanate component (D)(ii), with the reaction in the case of trifunctional isocyanates preferably being carried out in a molar ratio of 1:2:1 or 2:1:1 in any way,
and/or
c_{1.15}) reaction products of from 5 to 75% by weight of a monofunctional polyalkylene glycol component (G)(i) and/or a monofunctional polyoxyalkylenamine component (G)(ii), from 50 to 5% by weight of an aminosilane component (E)(i) and/or (E)(ii) and from 50 to 5% by weight of a triazine component (H) comprising cyanuric chloride or 2,4,6-trichloro-1,3,5-triazine, with the reaction preferably being carried out in a molar ratio of 1:2:1 or 2:1:1 in any way,
where the reaction products c_{1.10}) to c_{1.15}) contain from 0 to 10 parts by weight of a catalyst component (R), from 0 to 250 parts by weight of a solvent component (S)(i) and from 0 to 250 parts by weight of a solvent component (S)(ii),
by means of from 0.25 to 25 parts by weight of water,
c₂) partially or completely neutralizing the (amino-functional) adduct by means of from 0 to 75 parts by weight of an acid component (U)(iv) or from 0 to 75 parts by weight of another neutralization component (W),
c₃) if appropriate partially or completely removing the liberated alcohol and/or the solvent components (S)(i) and/or (S)(ii) by distillation before, during or after the reaction,
d₁) subsequently or simultaneously dissolving or dispersing and oligomerizing the reaction product from step c) in from 997.05 to 124 parts by weight of water,
d₂) if appropriate partially or completely removing the liberated alcohol and/or the solvent components (S)(i) and/or (S)(ii) by distillation before, during or after the reaction and, if appropriate, partially or completely removing the catalyst component (R) by means of suitable absorption materials or other measures before, during or after the reaction so that not more than from 0 to 1 part by weight of a catalyst component (R), from 0 to 25 parts by weight of a solvent component (S)(i) and from 0 to 25 parts by weight of a solvent component (S)(ii) are present,
e) where, if appropriate, during or after steps a) and/or b) and/or c) and/or d), from 0 to 50 parts by weight or from 0 to 60 parts by weight of a formulation component (Y)(i) is added in any way and/or from 0 to 50 parts by weight or from 0 to 60 parts by weight of a functionalization component (Z) comprising
e₁) an aminosilicone oil component (E)(iv) of the general formula
HO—[Si(CH₃)₂—O]_{c}—Si(CH₃)[(CH₂)₃NH(CH₂)₂NH₂]—O—[Si(CH₃)₂—O]_{c}—H
or
R′O—[Si(CH₃)₂—O]_{c}—Si(CH₃)[(CH₂)₃NH(CH₂)₂NH₂]—O—[Si(CH₃)₂—O]_{c}—R′
or
(H₃CO)₂Si[(CH₂)₃NH(CH₂)₂NH₂]—[Si(CH₃)₂—O]_{c}—Si[(CH₂)₃NH(CH₂)₂NH₂](OCH₃)₂
where c=1-100 and R′═H, Me, Et
and/or
e₂) a low molecular weight silane component (E)(v) of the general formula
R¹²—Si(OR¹)_{3-x′}R²_{x′}
where R¹²═OR¹, R²═, independently of one another, alkyl, cycloalkyl, aryl, any organic radical having 1-25 carbon atoms,
and/or
e₃) a hydrophilicized aqueous silane component (E)(vi) comprising (alcohol-free) aminosilane hydrolysates and/or (di/tri)amino/alkyl-functional siloxane cooligomers and/or amino/vinyl-functional siloxane cooligomers and/or epoxy-functional siloxane cooligomers
and/or
e₄) a (reactive) nanoparticle component (Y)(ii) comprising inorganic and/or organic nanoparticles or nanocomposites in the form of primary particles and/or aggregates and/or agglomerates, where the nanoparticles may be hydrophobicized and/or doped and/or coated and additionally surface-modified with reactive amino and/or hydroxyl and/or mercapto and/or isocyanato and/or epoxy and/or methacryloyl and/or silane groups of the general formula —Si(OR¹)_{3-x′}R²_{x′},
is/are added and/or coreacted.

2. A composition according to claim 1, wherein 3-isocyanatopropyltrimethoxysilane and/or 3-isocyanatopropyltriethoxysilane is used as component (C)(i).

3. A composition according to claim 1, wherein isophorone diisocyanate and/or tolylene diisocyanate is used as component (D)(i).

4. A composition according to claim 1, wherein an optionally hydrophilically modified trimer of 1,6-diisocyanatohexane is used as component (D)(ii).

5. A composition according to claim 1, wherein 3-aminopropyltrimethoxysilane and/or 3-aminopropyltriethoxysilane and/or N-(2-aminoethyl)-3-aminopropyltrimethoxysilane and/or N-(2-aminoethyl)-3-aminopropyltriethoxysilane and/or N—[N′-(2-aminoethyl)-2-aminoethyl]-3-aminopropyltrimethoxysilane is used as component (E)(i) and silanes of the formula
H₃C—O—(CH₂CH₂—O)_{z′}—(CH₂)₃—Si(OR¹)₃
where z′=5-15 and R¹=Me, Et,
are used as component (E)(iii).

6. A composition according to claim 1, wherein citric acid and/or hydroxypivalic acid and/or dimethylolpropionic acid is used as component (I).

7. A composition according to claim 1, wherein phosgene and/or ethyl chloroformate and/or diethyl carbonate and/or chloroformates or phosgene derivatives of the components (B)(i) and/or (B)(ii) and/or (B)(iii) and/or carbamates of the components (E)(i) and/or (E)(ii) are used as component (K).

8. A composition according to claim 1, wherein 3-mercaptopropyltrimethoxysilane and/or 3-mercaptopropyltriethoxysilane is used as component (L)(i).

9. A composition according to claim 1, wherein 4,4,5,5,6,6,7,7,8,8,9,9,9-tridecafluorononene 1,2-oxide and/or 4,4,5,5,6,6,7,7,8,8,9,9,10,10,11,11,11-heptadecafluoroundecene 1,2-oxide is used as component (M).

10. A composition according to claim 1, wherein 3-glycidyloxypropyltrimethoxysilane and/or 3-glycidyloxypropyltriethoxysilane is used as component (N)(i).

11. A composition according to claim 1, wherein ethylenediamine is used as component (O).

12. A composition according to claim 1, wherein diethanolamine and/or diisopropanolamine and/or trimethylolmethylamine and/or amino sugars are used as component (O).

13. A composition according to claim 1, wherein dibutyltin oxide and/or dibutyltin dilaurate (DBTL) and/or triethylamine and/or tin(II) octoate and/or 1,4-diazabicyclo[2.2.2]octane (DABCO) and/or 1,4-diazabicyclo[3.2.0]-5-nonene (DBN) and/or 1,5-diazabicyclo[5.4.0]-7-undecene (DBU) and/or morpholine derivatives such as JEFFCAT® Amine Catalysts are used as component (R).

14. A composition according to claim 1, wherein acetone and/or butanone and/or N-methyl-2-pyrrolidone and/or N-ethyl-2-pyrrolidone and/or dipropylene glycol dimethyl ether (Proglyde DMM®) are used as component (S)(i).

15. A composition according to claim 1, wherein methanol and/or ethanol and/or 2-propanol are used as component (S)(ii).

16. A composition according to claim 1, wherein acrylic acid is used as component (U)(i).

17. A composition according to claim 1, wherein maleic anhydride is used as component (U)(ii).

18. A composition according to claim 1, wherein D-gluconolactone is used as component (U)(ii).

19. A composition according to claim 1, wherein formic acid is used as component (U)(iv).

20. A composition according to claim 1, wherein triethylamine is used as component (W).

21. A composition according to claim 1, wherein (functionalized) inorganic and/or organic fillers and/or lightweight fillers, (functionalized) inorganic and/or organic pigments, (functionalized) inorganic and/or organic support materials, inorganic and/or organic fibres, graphite, carbon black, carbon fibres, carbon nanotubes, metal fibres and powders, conductive organic polymers, further polymers and/or redispersible polymer powders, superabsorbents, further inorganic and/or organic compounds, antifoams, deaerators, lubricants and levelling additives, substrate wetting additives, wetting additives and dispersants, hydrophobicizing agents, rheological additives, coalescence auxiliaries, matting agents, bonding agents, antifreezes, antioxidants, UV stabilizers, biocides, water, solvents, catalysts are used as component (Y)(i).

22. A composition according to claim 1, wherein (reactive) nanoparticles based on silicon dioxide and/or titanium dioxide and/or zinc oxide, where the nanoparticles are present in solid form and/or in the form of dispersions and/or pastes, are used as component (Y)(ii).

23. A composition according to claim 1, wherein at least 50% by weight of the total component (Y)(ii) has a particle size of not more than 500 nm (standard: DIN 53206-1, testing of pigments; particle size analysis, fundamentals) and the totality of the particles having this particle size of not more than 500 nm have a specific surface area (standard: DIN 66131, determination of the specific surface area of solids by gas adsorption using the Brunauer, Emmet and Teller (BET) method) of from 10 to 200 m²/g.

24. A composition according to claim 1, wherein at least 70% by weight, preferably at least 90% by weight, of the total component (Y)(ii) has a particle size of from 10 to 300 nm (standard: DIN 53206-1, testing of pigments; particle size analysis, fundamentals) and the totality of the particles having this particle size of from 10 to 300 nm have a specific surface area (standard: DIN 66131, determination of the specific surface area of solids by gas adsorption using the Brunauer, Emmet and Teller (BET) method) of from 30 to 100 m²/g.

25. A composition according to claim 1, wherein the components (Y)(i) and (Y)(ii) are present in coated and/or microencapsulated and/or supported and/or hydrophilicized and/or solvent-containing form and are liberated, if appropriate, in a retarded manner.

26. A process for producing the fluorine-containing compositions according to claim 1, wherein
a) a fluorosilane component (A)(i) is produced by reacting the components
a₁) (B)(i), (B)(ii), (B)(iii) and (C) and/or
a₂) (B)(i), (B)(ii), (B)(iii), (D)(i), (E)(i) and (E)(ii) and/or
a₃) (B)(iv), (E)(i) and (E)(ii) and/or
a₄) (B)(v), (E)(i) and (E)(ii) and/or
a₅) (F)(i), (E)(i) and (E)(ii) and/or
a₆) (F)(ii), (E)(i) and (E)(ii) and/or
a₇) (B)(i), (B)(ii), (B)(iii), (E)(i), (E)(ii) and (D)(ii) and/or
a₈) (B)(i), (B)(ii), (B)(iii), (E)(i), (E)(ii), (G)(i), (G)(ii) and (D)(ii) and/or
a₉) (B)(i), (B)(ii), (B)(iii), (E)(i), (E)(ii) and (H) and/or
a₁₀) (B)(i), (B)(ii), (B)(iii), (E)(i), (G)(i), (G)(ii) and (H) and/or
a₁₁) (B)(i), (B)(ii), (B)(iii), (E)(i), (G)(iii), (G)(iv) and (D)(i) and/or
a₁₂) (B)(i), (B)(ii), (E)(i), (E)(ii), (I) and (D)(ii) and/or
a₁₃) (B)(i), (B)(ii), (B)(iii), (E)(i), (E)(ii), (J) and (D)(ii) and/or
a₁₄) (B)(i), (B)(ii), (E)(i), (E)(ii) and (K) and/or
a₁₅) as per a₂) to a₁₄) with the components (E)(i) and E(ii) being replaced by the components (L)(i) and (L)(ii) and/or
a₁₆) (M), (E)(i) and (E)(ii) and/or
a₁₇) (M), (N)(i), (N)(ii) and (O) and/or
a₁₈) (P)(i), (E)(i) and (E)(ii) and/or
a₁₉) (P)(ii), (C)(i) and (C)(ii) and/or
a₂₀) (P)(iii), (Q)(i) and (Q)(ii)
or according to a₂₁) to a₂₂) preformed fluorosilanes (A)(ii) are used,
where, if appropriate, a catalyst component (R) and, if appropriate, a solvent component (S)(i) is/are present in addition to the pure fluorosilane component (A); and subsequently
b₁) if appropriate, the solvent component (S)(i) from step a) is partially or completely removed by distillation before, during or after the reaction,
b₂) if appropriate, the catalyst component (R) from step a) is partially or completely removed by means of suitable absorption materials or other measures after the reaction,
b₃) if appropriate, the fluorosilane component (A) from step a) is dissolved in the solvent component (S)(ii) before, during or after the reaction,
or
c₁) the fluorosilane component (A) from step a) or b), if appropriate in the presence of an aminoalkylalkoxysilane component (E)(i) and/or an aminosilane component (E)(ii) and/or a stabilizing component (T) comprising reaction products of the components
c_{1.1}) (Q)(i), (Q)(ii), (C)(i) and (C)(ii) and/or
c_{1.2}) (Q)(i) (Q)(ii), (E)(i), (E)(ii) and (D)(i) and/or
c_{1.3}) (I), (C)(i) and (C)(ii) and/or
c_{1.4}) (I), (E)(i), (E)(ii) and (D)(i) and/or
c_{1.5}) (J), (C)(i) and (C)(ii) and/or
c_{1.6}) (J), (E)(i), (E)(ii) and (D)(i) and/or
c_{1.7}) (E)(i), (E)(ii) and (U)(i) and/or
c_{1.8}) (E)(i), (E)(ii) and (U)(ii) and/or
c_{1.9}) (E)(i), (E)(ii) and (U)(iii),
where, if appropriate, a catalyst component (R), if appropriate a solvent component (S)(i) and, if appropriate, a solvent component (S)(ii) are present in addition to the pure stabilizing component (T),
and a hydrophilic silane component (V) comprising
c_{1.10}) (E)(iii) and/or reaction products of the components
c_{1.11}) (G)(i), (G)(ii), (G)(iii), (G)(iv), (C)(i) and (C)(ii) and/or
c_{1.12}) (G)(i) and (G)(ii) (G)(iii) (G)(iv), (E)(i) (E)(ii) and (D)(i) and/or
c_{1.13}) (G)(ii), (G)(iv), (N)(i) and (N)(ii) and/or
c_{1.14}) (G)(i), (G)(ii), (E)(i), (E)(ii) and (D)(ii) and/or
c_{1.15}) (G)(i), (G)(ii), (E)(i), (E)(ii) and (H),
where, if appropriate, a catalyst component (R), if appropriate a solvent component (S)(i) and, if appropriate, a solvent component (S)(ii) are present in addition to the pure hydrophilic silane component (V),
are (partially) hydrolyzed or silanolized by means of water,
c₂) the (amino-functional) adduct is partially or completely neutralized by means of acid component (U)(iv) or another neutralization component (W),
c₃) if appropriate, the liberated alcohol and/or the solvent components (S)(i) and/or (S)(ii) is/are partially or completely removed by distillation before, during or after the reaction,
d₁) the reaction product from step c) is subsequently or simultaneously dissolved or dispersed and oligomerized in water,
d₂) if appropriate, the liberated alcohol and/or the solvent components (S)(i) and/or (S)(ii) is/are partially or completely removed by distillation before, during or after the reaction and, if appropriate, the catalyst component (R) is partially or completely removed by means of suitable absorption materials or other measures before, during or after the reaction so that not more than from 0 to 1 part by weight of a catalyst component (R), from 0 to 25 parts by weight of a solvent component (S)(i) and from 0 to 25 parts by weight of a solvent component (S)(ii) are present,
e) where, if appropriate, a formulation component (Y)(i) can be added and/or a functionalization component (Z) comprising the components
e₁) (E)(iv) and/or
e₂) (E)(v) and/or
e₃) (E)(vi) and/or
e₄) (Y)(ii),
can be added and/or coreacted during or after steps a) and/or b) and/or c) and/or d).

27. A process according to claim 26, wherein the components (A)(i) from reaction step a) and (V) from reaction step c) are prepared or blended simultaneously.

28. A process according to claim 27, wherein the reaction steps c) and d) or b), c) and d) are combined in any way and order.

29. A process according to claim 26, wherein a (partial) transesterification of the alkoxysilane groups of the fluorosilane component (A) with an alcoholic solvent component (S)(ii) is additionally carried out in step b₃).

30. A process according to claim 26, wherein the liberated alcohol and/or the solvent components (S)(i) and/or (S)(ii) is removed by, if appropriate azeotropic, distillation in steps c₃) and d₂) and, if appropriate, the water removed is subsequently or simultaneously replaced.

31. A process according to claim 26, wherein the acid component (U)(iv) is initially charged together with the water in step c).

32. A process according to claim 26, wherein the fluorine-containing compositions or (per)fluoroalkyl-functional organosilanes as per reaction steps a) and b) are used in single-component form.

33. A process according to claim 26, wherein the fluorine-containing compositions or (per)fluoroalkyl-functional organosiloxane precondensates or (per)fluoroalkyl-functional organosiloxane condensates as per reaction steps c) and d) are used in single-component form.

34. A process according to claim 26, wherein reaction step a) is carried out at a temperature of from 40 to 120° C.

35. A process according to claim 26, wherein reaction steps b) to e) are carried out at a temperature of from 20 to 120° C.

36. A process according to claim 26, wherein the equivalence ratio of fluorine atoms to nitrogen atoms in the reaction products of steps c) and d) is set to from 1:50 to 50:1.

37. A process according to claim 26, wherein the equivalence ratio of alkoxysilane groups to water in step c) is set to from 1:10 to 10:1.

38. A process according to claim 26, wherein the molar ratio of silicon atoms to water in step c) is set to from 1:10 to 10:1.

39. A process according to claim 26, wherein the solids content of the fluorine-containing compositions comprising the components (A), (Y)(i) and (Z) in reaction steps a) and b) is set to from 5 to 100% by weight.

40. A process according to claim 26, wherein the solids content of the fluorine-containing compositions comprising the components (A), (E), (U)(iv), (T), (V), (Y)(i) and (Z) in reaction step c) is set to from 25 to 100% by weight.

41. A process according to claim 26, wherein the solids content of the fluorine-containing compositions comprising the components (A), (E), (U)(iv), (T), (V), (Y)(i) and (Z) in reaction step d) is set to from 0.001 to 100% by weight.

42. A process according to claim 26, wherein the pH of the fluorine-containing compositions in reaction steps c) and d) is set to from 1 to 14.

43. A process according to claim 26, wherein the viscosity (Brookfield) of the fluorine-containing compositions in reaction steps c) and d) is set to from 1 to 100 mPa·s.

44. A method comprising using the fluorine-containing composition according to claim 1 in the building sector or the industrial sector for the permanent oil-, water- and dirt-repellent surface treatment or modification of substrates and in particular mineral and nonmineral substrates, e.g.
inorganic surfaces, e.g. porous and nonporous, absorbent and nonabsorbent, rough and polished building materials and materials of construction of all types based on cement (concrete, mortar), lime, gypsum plaster, anhydrite, geopolymers, silica and silicates, synthetic stone (e.g. granite, marble, sandstone, slate, serpentine), natural stone, clay, cement and also enamels, fillers and pigments, glass and glass fibres, ceramic, metals and metal alloys,
organic surfaces, e.g. wovens and textiles, wood and wood materials, rubber, wood veneer, glass-reinforced plastics (GRP), plastics, leather and artificial leather, natural fibres, paper, polymers of all types,
composites of all types, if appropriate with nanosize constituents.

45. The method according to claim 44 in the on-site and/or off-site sector of building and industry, e.g. for the applications
hydrophobicization and oleophobicization
antigraffiti
antisoiling
easy-to-clean
low dirt pick-up
nanostructured surfaces with Lotus-Effekt®
building protection
corrosion protection
seals
coatings
impregnation
surface sealing, in particular for permanent oil-, water- and dirt-repellent surface treatment or modification.

46. The method according to claim 44 for the application areas
additives for paints and coating systems
automobile and motor vehicle industry
finished concrete parts
concrete moldings
in-situ concrete
spray concrete
ready-mixed concrete
roofing tiles
electrical and electronics industry
paints and varnishes
tiles and grouting
wovens and textiles
glass facades and glass surfaces
wood machining and processing (veneers, impregnation)
ceramics and sanitaryware
adhesives and sealants
corrosion protection
plastic films
acoustic insulation walls
leather treatment
surface modification of fillers, pigments, nanoparticles
paper and board coating
plasters and renders, including decorative plasters and renders
thermal insulation composite systems (TICS) and thermal insulation systems (TIS) fibrocement boards.

47. The method according to claim 44 for the full-body hydrophobicization/oleophobicization of concrete compositions and concrete products, e.g.
on-site concrete
concrete products (finished concrete parts, concrete wares, concrete bricks/blocks)
in-situ concrete
spray concrete
ready-mixed concrete.

48. The method according to claim 44 as monomers or macromonomers for sol-gel systems.

49. The method according to claim 44, wherein the coating system is used in an amount of from 0.00001 to 1 kg per m² of the surface to be coated and per operation.

50. The method according to claim 44, wherein the (per)fluoroalkyl-functional organosiloxane precondensates or (per)fluoroalkyl-functional organosiloxane condensates as per reaction steps c) and d) are applied using HVLP technology.
